(19) United States
(12) Patent Application Publication
(10) Pub. No.: US 2026/0301650 A1
(43) Pub. Date: Oct. 1, 2026

(54) SCAN DRIVER, DISPLAY DEVICE INCLUDING THE SAME, AND ELECTRONIC DEVICE

(71) Applicant: Samsung Display Co., Ltd., Yongin-si (KR)

(72) Inventors: Dong Hwan JEON, Yongin-si (KR); Min Joo KIM, Yongin-si (KR); Min Woo BYUN, Yongin-si (KR); Kyong Hwan OH, Yongin-si (KR)

(21) Appl. No.: 19/410,766

(22) Filed: Dec. 5, 2025

(30) Foreign Application Priority Data
Mar. 28, 2025 (KR) 10-2025-0040440

(51) Int. Cl. G09G 3/32; G09G 3/3266

(52) U.S. Cl. CPC G09G 3/32; G09G 3/3266; G09G 2310/0267

(57) ABSTRACT

A scan driver includes: a plurality of stage circuits configured to supply a scan signal to scan lines, wherein at least one of the plurality of stage circuits includes: a carry output part configured to carry a carry signal in response to a voltage of a first control node; a scan output part configured to output the scan signal in response to a voltage of a second control node; and a control part connected between the first control node and the second control node, and configured to control an electrical connection between the first control node and the second control node in response to a frequency control signal.

### CROSS-REFERENCE TO RELATED APPLICATION

This application claims priority to and the benefit of Korean Patent Application Number 10-2025-0040440, filed on Mar. 28, 2025, in the Korean Intellectual Property Office, the entire disclosure of which is incorporated by reference herein.

### BACKGROUND

### 1. Field

Aspects and features of embodiments of the present disclosure relate to a scan driver, a display device including the same, and an electronic device.

### 2. Description of the Related Art

With the development of information technology, the demand for display devices for displaying images is increasing in various forms. For example, display devices are applied to various electronic devices such as smartphones, digital cameras, notebook computers, car navigation systems, and/or smart televisions.

A display device includes pixels to display images. The display device may include a scan driver to drive the pixels. The scan driver may include stage circuits and supply at least one scan signal to each of the scan lines for each frame by using the stage circuit.

### SUMMARY

The present disclosure provides a scan driver configured to stably supply scan signals when at least two areas of a display panel are driven at different driving frequencies, a display device including the scan driver, and an electronic device including the display device.

According to one or more embodiments of the present disclosure, a scan driver includes: a plurality of stage circuits configured to supply a scan signal to scan lines, wherein at least one of the plurality of stage circuits includes: a carry output part configured to carry a carry signal in response to a voltage of a first control node; a scan output part configured to output the scan signal in response to a voltage of a second control node; and a control part connected between the first control node and the second control node, and configured to control an electrical connection between the first control node and the second control node in response to a frequency control signal.

In one or more embodiments, the control part is configured to electrically connect the first control node and the second control node when the frequency control signal is at a first level, and configured to electrically disconnect the first control node and the second control node when the frequency control signal is at a second level.

In one or more embodiments, the at least one of the plurality of stage circuits further includes: an input part configured to control the voltage of the first control node in response to a start signal or a carry signal from a previous stage circuit; and a first inverter part configured to control a voltage of a first driving node in response to the voltage of the first control node.

In one or more embodiments, the control part includes: a first control transistor connected between the first control node and the second control node; a second control transistor connected between a control input terminal to which the frequency control signal is input and a gate electrode of the first control transistor, the second control transistor including a gate electrode connected to the first driving node; and a control capacitor connected between the gate electrode of the first control transistor and a first low power input terminal to which a first logic low voltage is input.

In one or more embodiments, the at least one of the plurality of stage circuits further includes a second inverter part configured to control a voltage of a second driving node in response to the voltage of the first control node.

In one or more embodiments, the first inverter part is driven when a first control power is at a high voltage, and the second inverter part is driven when a second control power is at a high voltage, and wherein the first control power and the second control power alternate between the high voltage and a low voltage in units of at least one frame.

In one or more embodiments, the control part further includes a third control transistor connected in parallel with the second control transistor, the third control transistor including a gate electrode connected to the second driving node.

In one or more embodiments, the at least one of the plurality of stage circuits further includes: a reset part connected to a second low power input terminal to which a second logic low voltage is input, the reset part being configured to initialize the first control node, the first driving node, and the second driving node in response to a reset signal; and a stabilization part configured to supply the second logic low voltage to the second control node in response to a carry clock signal.

In one or more embodiments, the control part includes: a first control transistor connected between the first control node and the second control node, a second control transistor connected between a control input terminal to which the frequency control signal is input and a gate electrode of the first control transistor, the second control transistor including a gate electrode configured to receive a carry clock signal; and a control capacitor connected between the gate electrode of the first control transistor and a first low power input terminal to which a first logic low voltage is input.

In one or more embodiments, the at least one of the plurality of stage circuits further includes: an input part configured to control the voltage of the first control node in response to a start signal or a carry signal from a previous stage circuit; a driving transistor connected between the first control node and the first control node, the driving transistor including a gate electrode connected to a high power input terminal to which a logic high voltage is input such that the driving transistor is maintained in a turn-on state; and a first inverter part configured to control a voltage of a first driving node in response to the voltage of the first control node.

In one or more embodiments, the control part includes: a first control transistor connected between the first control node and the second control node; a second control transistor connected between a control input terminal to which the frequency control signal is input and a gate electrode of the first control transistor, the second control transistor including a gate electrode connected to the first driving node; and a control capacitor connected between a gate electrode of the first control transistor and the high power input terminal.

In one or more embodiments, the at least one of the plurality of stage circuits further includes a second inverter part configured to control a voltage of a second driving node in response to the voltage of the first control node.

In one or more embodiments, the first inverter part is driven when a first control power is at a high voltage, and the second inverter part is driven when a second control power is at a high voltage, and wherein the first control power and the second control power alternate between the high voltage and a low voltage in units of at least one frame.

In one or more embodiments, the control part further includes a third control transistor connected in parallel with the second control transistor, the third control transistor includes a gate electrode connected to the second driving node.

In one or more embodiments, the at least one of the plurality of stage circuits further includes: a reset part connected to a low voltage input terminal to which a logic low voltage is input, the reset part being configured to initialize the first control node, the first driving node, and the second driving node in response to a reset signal; a stabilization part configured to control whether the logic low voltage is supplied to the second control node of or not in response to the voltage of the first driving node and the voltage of the second driving node; a first boosting part configured to control the voltage of the first control node in response to a clock signal when the clock signal is input; and a second boosting part configured to control the voltage of the second control node in response to the clock signal when the clock signal is input.

In one or more embodiments, a display device, includes: a display panel including pixels connected to scan lines and data lines; and a scan driver having a plurality of stage circuits configured to supply a scan signal to the scan lines, wherein at least one of the plurality of stage circuits includes: a carry output part configured to output a carry signal in response to a voltage of a first control node; a scan output part configured to output the scan signal in response to a voltage of a second control node; and a control part connected between the first control node and the second control node, and configured to control an electrical connection between the first control node and the second control node in response to a frequency control signal.

In one or more embodiments, the control part is configured to electrically connect the first control node and the second control node when the frequency control signal is at a first level, and configured to electrically disconnect the first control node and the second control node when the frequency control signal is at a second level.

In one or more embodiments, the display panel further includes a first area and a second area, and the first area and the second area are driven at different driving frequencies when the first area and the second area are supplied with different levels of the frequency control signal.

In one or more embodiments, an electronic device, includes: a processor; a display module configured to display image information under control of the processor; and a memory configured to store data information for operations of the processor and the display module, wherein the display module includes: a display panel including pixels connected to scan lines and data lines; and a scan driver including a plurality of stage circuits configured to supply a scan signal to the scan lines, and wherein at least one of the plurality of stage circuits includes: a carry output part configured to carry a carry signal in response to a voltage of a first control node; a scan output part configured to output the scan signal in response to a voltage of a second control node; and a control part connected between the first control node and the second control node, and configured to control an electrical connection between the first control node and the second control node in response to a frequency control signal.

In one or more embodiments, the control part electrically connects the first control node and the second control node when the frequency control signal is at a first level, and electrically disconnects the first control node and the second control node when the frequency control signal is at a second level.

### BRIEF DESCRIPTION OF THE DRAWINGS

The above and other aspects and features of embodiments according to the present disclosure will become more apparent by describing, in further detail, aspects of some embodiments thereof with reference to the accompanying drawings, in which:

FIG. 1 is a block diagram illustrating a display device according to one or more embodiments of the present disclosure;

FIG. 2 is a block diagram illustrating one or more embodiments of a scan driver and an emission driver shown in FIG. 1;

FIG. 3 is a circuit diagram illustrating a pixel according to one or more embodiments of the present disclosure;

FIG. 4 is a waveform diagram illustrating a method of driving the pixel of FIG. 3 during a write period, according to one more embodiments;

FIG. 5 is a waveform diagram illustrating one embodiment of a method of driving the pixel of FIG. 3 during a hold period, according to one more embodiments;

FIG. 6 is a block diagram illustrating a first scan driver according to one or more embodiments of the present disclosure;

FIG. 7 is a waveform diagram illustrating clock signals shown in FIG. 6, according to one more embodiments;

FIG. 8 is a waveform diagram illustrating a control power as shown in FIG. 6, according to one more embodiments;

FIG. 9 is a circuit diagram illustrating a stage circuit as shown in FIG. 6, according to one more embodiments;

FIG. 10 is a waveform diagram illustrating a method of driving the stage circuit as shown in FIG. 9, according to one more embodiments;

FIG. 11 is a waveform diagram illustrating another method of driving the stage circuit as shown in FIG. 9, according to one more embodiments;

FIG. 12 is a waveform diagram indicating whether a scan signal corresponding to a frequency control signal is output, according to one more embodiments;

FIG. 13 is a block diagram illustrating a third scan driver according to one or more embodiments of the present disclosure;

FIG. 14 is a circuit diagram illustrating embodiments of a stage circuit as shown in FIG. 13, according to one more embodiments;

FIG. 15 is a waveform diagram illustrating a method of driving the stage circuit as shown in FIG. 14, according to one more embodiments;

FIG. 16 is a waveform diagram illustrating another method of driving the stage circuit as shown in FIG. 14, according to one more embodiments;

FIG. 17 is a waveform diagram indicating whether a scan signal corresponding to a frequency control signal is output, according to one more embodiments;

FIG. 18 is a diagram indicating a case in which a display panel is divided into a plurality of areas, and the plurality of regions are driven at different driving frequencies, according to one more embodiments;

FIG. 19 is a circuit diagram illustrating a stage circuit as shown in FIG. 6, according to one more embodiments;

FIGS. 20 to 22 are circuit diagrams illustrating a stage circuit according to one or more embodiments of the present disclosure;

FIG. 23 is a diagram illustrating an electronic device according to one or more embodiments of the present disclosure; and

FIG. 24 shows schematic views of various embodiments of an electronic device.

### DETAILED DESCRIPTION

Hereinafter, aspects and features of embodiments of the present disclosure are described in more detail with reference to the accompanying drawings so that those skilled in the art may easily practice the present disclosure. The present disclosure may be implemented in various different forms and is not limited to embodiments described in the present specification.

A part irrelevant to the description will be omitted to clearly describe the present disclosure, and the same or similar constituent elements will be designated by the same reference numerals throughout the specification. Therefore, the same reference numerals may be used in different drawings to identify the same or similar elements.

In the specification, the expression “equal” may mean “substantially equal.” That is, this may mean equality to a degree to which those skilled in the art can understand the equality. Other expressions may be expressions in which “substantially” is omitted.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and/or other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in one or more embodiments, the block, unit, and/or module may be physically separated into two or more interact individual blocks, units, and/or modules without departing from the spirit and scope of the present disclosure. In addition, in one or more embodiments, the block, unit and/or module may be physically combined into more complex blocks, units, and/or modules without departing from the spirit and scope of the present disclosure.

The term “connection” between the two components may encompass both electrical and physical connections, but is not necessarily limited thereto. For instance, the term “connection” as used in a circuit diagram may refer to an electrical connection, whereas the term “connection” as used in a cross-sectional view or a plan view may refer to a physical connection.

Terms such as “first” and “second” may be used to describe various components, but these components are not limited to these terms. These terms are used to distinguish one component from another component. Therefore, a first component may refer to a second component within a range without departing from the scope disclosed herein. “At least one of X, Y, and Z” and “at least one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

The present disclosure may not be limited to embodiments described below and may be modified and implemented in various forms. Furthermore, each of embodiments disclosed herein may be practiced alone or in combination with at least one other embodiment.

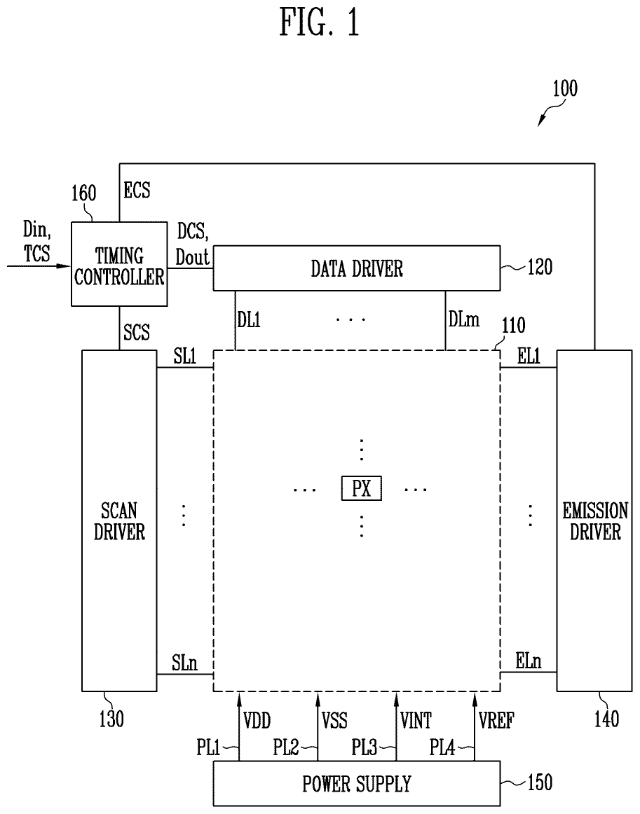

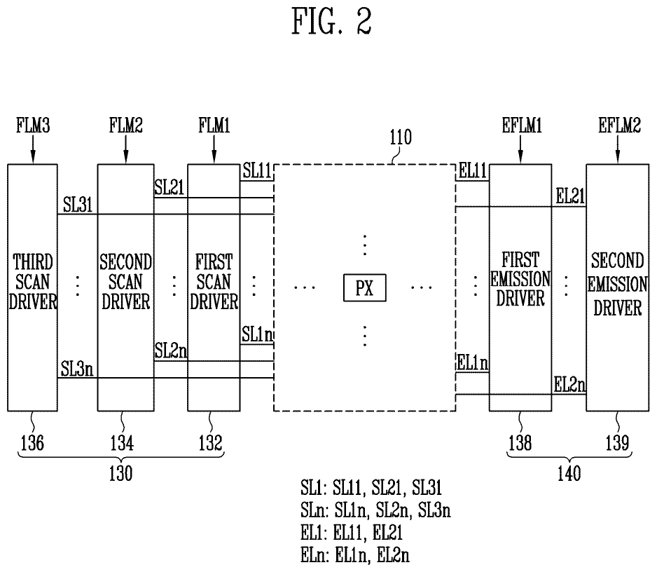

FIG. 1 is a block diagram illustrating a display device 100 according to one or more embodiments of the present disclosure. FIG. 2 is a block diagram illustrating one or more embodiments of a scan driver 130 and an emission driver 140 as shown in FIG. 1.

Referring to FIG. 1, the display device 100 according to one or more embodiments of the present disclosure may include a display panel 110, a data driver 120, the scan driver 130, the emission driver 140, a power supply 150, and a timing controller 160.

The display device 100 may display video at various video refresh rates (e.g., at various driving frequencies or refresh rates) depending on the driving conditions. A video refresh rate refers to the frequency at which a data signal is written to a driving transistor of a pixel PX. For example, the video refresh rate may be referred to as a screen scanning rate or a display frame rate, which may present a frequency at which a display screen is refreshed per second.

In one or more embodiments, an output frequency of the scan driver 130 for outputting the scan signal and/or an output frequency of the data driver 120 for one horizontal line (e.g., the pixels PX connected to the same scan line may be classified as one horizontal line (or a pixel row)) may be determined in response to a video refresh rate.

For example, each of the scan lines SL1 to SLn as shown in FIG. 1 may include three scan lines, as shown in FIG. 2. The scan line SL1 may include a first scan line SL11, a second scan line SL21, and a third scan line SL31. The scan line SLn may include a first scan line SL1n, a second scan line SL2n, and a third scan line SL3n. A frequency of the first scan signal (or a write scan signal) output from a first scan driver 132 may be determined by a video refresh rate.

The video refresh rate for driving video may be a frequency of about 60 Hz or more (e.g., 120 Hz, 240 Hz, etc.). For example, the display device 100 may display a video in response to various video refresh rates from 1 Hz to 240 Hz. However, this is merely an example, and the display device 100 may also display video at video refresh rates greater than 240 Hz (e.g., 480 Hz).

The display panel 110 may include the pixels PX in connection with the scan lines SL1 to SLn, data lines DL1 to DLm, emission control lines EL1 to ELn, and power lines PL1, PL2, PL3, and PL4, where n are m are natural numbers of two or more.

The pixels PX are selected in units of a horizontal line when an enabled first scan signal is supplied to the first scan lines SL11 to SL1n, and the pixels PX selected by the enabled first scan signal may receive a data signal from a data line (one of the data lines DL1 to DLm) connected thereto. The pixels PX supplied with the data signal may generate light of a desired luminance (e.g., a predetermined luminance) in response to a voltage of the data signal.

The scan driver 130 may receive a scan driving signal SCS from the timing controller 160. The scan driving signal SCS may include at least one scan start signal and clock signals for driving the scan driver 130. The scan driver 130 may generate an enabled first scan signal, an enabled second scan signal, and an enabled third scan signal by shifting the scan start signal in response to the clock signal.

In one or more embodiments, the scan driver 130 may include the first scan driver 132 (or a write driver), a second scan driver 134 (or an initialization driver), and a third scan driver 136 (or a control driver), as shown in FIG. 2. Depending on the design, at least portions of the scan drivers 132, 134, and 136 may be integrated into a single drive circuit, module, and/or the like.

The first scan driver 132 may receive a first scan start signal FLM1 and generate an enabled first scan signal by shifting the first scan start signal FLM1 in response to a clock signal. The first scan driver 132 may sequentially supply the enabled first scan signal to the first scan lines SL11 to SL1n. In one or more embodiments, the first scan driver 132 may supply the enabled first scan signal during a write period of an active period of one frame.

The second scan driver 134 may receive a second scan start signal FLM2, and may generate an enabled second scan signal by shifting the second scan start signal FLM2 in response to the clock signal. The second scan driver 134 may sequentially supply the enabled second scan signal to the second scan lines SL21 to SL2n. In one or more embodiments, the second scan driver 134 may supply the enabled second scan signal during the write period of the active period of one frame. In one or more embodiments, the second scan driver 134 may supply the enabled second scan signal during an active period and/or a hold period included in a blanking period of one frame.

For example, the second scan driver 134 may perform scanning once during the write period of one frame (i.e., supply at least one enabled second scan signal) and may perform scanning at least once during the hold period of one frame, depending on a video refresh rate. When the video refresh rate is reduced (i.e., a frame length is increased), the number of hold periods included in the blanking period of one frame may be increased because the blanking period is lengthened. That is, the number of repetitions of the operation of supplying the enabled second scan signal may be increased when the video refresh rate is reduced.

The third scan driver 136 may receive a third scan start signal FLM3, and may generate an enabled third scan signal by shifting the third scan start signal FLM3 in response to the clock signal. The third scan driver 136 may sequentially supply enabled third scan signals to the third scan lines SL31 to SL3n. In one or more embodiments, the third scan driver 136 may supply the enabled third scan signal during the write period of the active period of one frame.

The enabled first scan signal, the enabled second scan signal, and the enabled third scan signal may have a gate-on voltage such that the transistors included in the pixels PX may be turned on. For example, the enabled first scan signal, the enabled second scan signal, and the enabled third scan signal supplied to an N-type transistor may be set to a logic high level voltage.

The data driver 120 may receive output data Dout and a data driving signal DCS from the timing controller 160. The data driving signal DCS may include a sampling signal and/or timing signals for driving the data driver 120. The data driver 120 may generate a data signal based on the data driving signal DCS and the output data Dout. For example, the data driver 120 may generate an analog data signal based on a gradient of the output data Dout. The data driver 120 may supply the data signal to the data lines DL1 to DLm in units of one horizontal period.

In one or more embodiments, each of the emission control lines EL1 to ELn may include two emission control lines as shown in FIG. 2. For example, the emission control line EL1 may include a first emission control line EL11 and a second emission control line EL21. For example, the emission control line ELn may include a first emission control line EL1n and a second emission control line EL2n.

The emission driver 140 may receive an emission driving signal ECS from the timing controller 160. The emission driving signal ECS may include an emission start signal and clock signals for driving the emission driver 140. The emission driver 140 may generate a disabled first emission control signal and a disabled second emission control signal by shifting the emission start signal in response to the clock signal.

In one or more embodiments, the emission driver 140 may include a first emission driver 138 and a second emission driver 139 as shown in FIG. 2. Depending on the design, at least portions of the emission drivers 138 and 139 may be integrated into a single drive circuit, module, and/or the like.

The first emission driver 138 may generate a disabled first emission control signal by shifting a first emission start signal EFLM1 in response to a clock signal. The first emission driver 138 may sequentially supply the disabled first emission control signal to the first emission control lines EL11 to EL1n. The first emission driver 138 may supply an enabled first emission control signal to the first emission control lines EL11 to EL1n during a period when the disabled first emission control signal is not supplied.

In one or more embodiments, the first emission driver 138 may supply the disabled first emission control signal during a write period and a hold period of one frame. For example, the first emission driver 138 may perform scanning at least once during the write period of the one frame, and may perform scanning at least once during the hold period according to the video refresh rate. When the video refresh rate is reduced (i.e., when the frame length is increased), the number of hold periods included in the blanking period of one frame may be increased because the blanking period is lengthened. That is, the number of repetitions of the operation of supplying the disabled first emission control signal may be increased when the video refresh rate is reduced.

The second emission driver 139 may generate the disabled second emission control signal by shifting a second emission start signal EFLM2 in response to the clock signal. The second emission driver 139 may sequentially supply the disabled second emission control signal to the second emission control lines EL21 to EL2n. The second emission driver 139 may supply an enabled second emission control signal to the second emission control lines EL21 to EL2n during a period when the disabled second emission control signal is not supplied. In one or more embodiments, the second emission driver 139 may supply the disabled second emission control signal during the write period of the one frame.

The disabled first emission control signal and the disabled second emission control signal may be set to a gate-off voltage such that the transistors included in the pixels PX may be turned off. In one example, the disabled first emission control signal and the disabled second emission control signal supplied to the N-type transistor may be set to a logic low level voltage.

The enabled first emission control signal and the enabled second emission control signal may be set to a gate-on voltage such that the transistors included in the pixel PX may be turned on. For example, the enabled first emission control signal and the enabled second emission control signal supplied to the N-type transistor may be set to a logic high level voltage.

The timing controller 160 may receive input data Din and timing control signals TCS from a host system via an interface. For example, the timing controller 160 may receive the input data Din and the timing control signal TCS from at least one of a Graphics Processing Unit (GPU), a Central Processing Unit (CPU), or an Application Processor (AP) included in the host system. The timing control signal TCS may include various signals, including a clock signal.

Based on the timing control signal TCS, the timing controller 160 may generate the scan driving signal SCS, the data driving signal DCS, and the emission control signal ECS. The scan driving signal SCS, the data driving signal DCS, and the emission driving signal ECS may be supplied to the scan driver 130, the data driver 120, and the emission driver 140, respectively.

The timing controller 160 may rearrange the input data Din to meet the specifications of the display device 100. Further, the timing controller 160 may compensate the input data Din to generate the output data Dout, and may supply the output data Dout to the data driver 120. In one or more embodiments, the timing controller 160 may compensate the input data Din in response to optical measurement results obtained during the process.

The power supply 150 may generate various power sources for driving the display device 100. For example, the power supply 150 may generate a first driving power VDD, a second driving power VSS, an initialization voltage VINT, and a reference voltage VREF.

The first driving power VDD may be a power source that supplies a driving current to the pixels PX. The second driving power VSS may be a power source that receives a driving current from the pixel PX. The first driving power VDD may be set to a voltage higher than the second driving power VSS during the period when the pixels PX are set to an emission state.

The initialization voltage VINT may be supplied to a first electrode (or an anode electrode) of a light emitting element included in each of the pixels. The reference voltage VREF may be supplied to a gate electrode of a driving transistor included in each of the pixels.

The first driving power VDD generated by the power supply 150 may be supplied to the first power line PL1, the second driving voltage VSS may be supplied to the second power line PL2, the initialization voltage VINT may be supplied to the third power line PL3, and the reference voltage VREF may be supplied to the fourth power line PL4. The first power line PL1, the second power line PL2, the third power line PL3, and the fourth power line PL4 may be connected in common with the pixels PX, but the present disclosure is not limited thereto.

In one or more embodiments, the first power line PL1 includes a plurality of power lines, and the plurality of power lines may be connected to different pixels PX. In one or more embodiments, the second power line PL2 includes a plurality of power lines, and the plurality of power lines may be connected to different pixels PX. In one or more embodiments, the third power line PL3 includes a plurality of power lines, and the plurality of power lines may be connected to different pixels PX. In one or more embodiments, the fourth power line PL4 includes a plurality of power lines, and the plurality of power lines may be connected to different pixels PX.

In one or more embodiments of the present disclosure, the display device 100 may include a flat display device, a curved display device in which a portion of the display panel 110 is curved, a flexible display device in which a portion may be folded and/or bent, and a stretchable display device in which a portion is stretched.

In one or more embodiments of the present disclosure, the display device 100 displays video and/or still images, and may include a portable electronic device such as a mobile phone, a smart phone, a tablet personal computer (tablet PC), a smart watch, a watch phone, a mobile communication terminal, an electronic notebook, an electronic book, a portable multimedia player (PMP), a navigation device, and/or an ultra-mobile PC (UMPC). In one or more embodiments of the present disclosure, the display device 100 may include an electronic device such as a television, a laptop, a monitor, a billboard, and/or the Internet of Things (IoT).

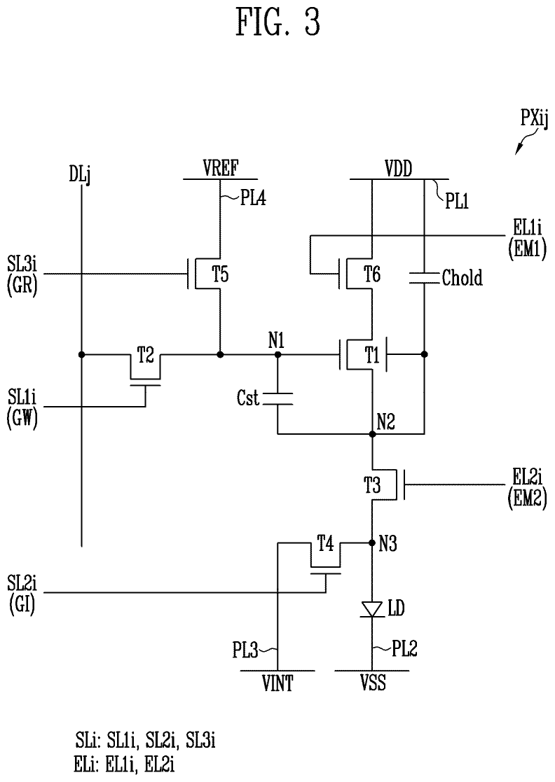

FIG. 3 is a circuit diagram illustrating a pixel according to one or more embodiments of the present disclosure. FIG. 3 illustrates a pixel positioned on an i-th horizontal line and a j-th vertical line.

Referring to FIG. 3, a pixel PXij according to one or more embodiments of the present disclosure may be connected to corresponding signal lines (SLi, DLj, and ELi). For example, the pixel PXij may be connected to an i-th scan line SLi, an i-th emission control line ELi, and a j-th data line DLj, where i is a natural number from 1 to n, and j is a natural number from 1 to m. The i-th scan line SLi may include a plurality of scan lines SL1i, SL2i, and SL3i. The i-th emission control line ELi may include a plurality of emission control lines EL1i and EL2i. The pixel PXij may be further connected to the power lines PL1 to PL4.

The pixel PXij according to one or more embodiments of the present disclosure may include a light emitting element LD, and a pixel circuit for controlling the amount of current supplied to the light emitting element LD.

The light emitting element LD may be connected between the first power line PL1 and the second power line PL2. For example, a first electrode (e.g., an anode electrode) of the light emitting element LD may be connected to the first power line PL1 via a third node N3, a third transistor T3, a second node N2, a first transistor T1, and a sixth transistor T6, and a second electrode (e.g., a cathode electrode) of the light emitting element LD may be connected to the second power line PL2. The light emitting element LD may generate light of a luminance corresponding to the amount of current supplied from the pixel circuit.

The light emitting element LD may be configured as an organic light emitting diode (OLED). In addition, the light emitting element LD may be configured as an inorganic light emitting diode, such as a micro light emitting diode (micro LED) or a quantum dot light emitting diode. The light emitting element LD may also include a combination of organic and inorganic materials. In FIG. 3, the pixel PXij is shown to include a single light emitting element LD. However, in one or more other embodiments, the pixel PXij may include a plurality of light emitting elements LD, and the plurality of light emitting element LD may be connected in series, parallel, or series-parallel with each other.

The pixel circuit may include the first transistor T1, a second transistor T2, the third transistor T3, a fourth transistor T4, a fifth transistor T5, the sixth transistor T6, a first capacitor Cst, and a second capacitor Chold. The first to sixth transistors T1 to T6 may be oxide semiconductor transistors. For example, the first to sixth transistors T1 to T6 may include an active layer (or a semiconductor layer) including an oxide semiconductor layer. In one or more embodiments, the first to sixth transistors T1 to T6 may be N-type oxide semiconductor transistors.

A first electrode of the first transistor T1 (or a driving transistor) may be connected to a second electrode of the sixth transistor T6, and a second electrode of the first transistor T1 may be connected to the second node N2. A first gate electrode of the first transistor T1 may be connected to a first node N1, and a second gate electrode (or a back gate electrode) of the first transistor T1 may be connected to the second node N2. Thus, the first transistor T1 may control the amount of driving current flowing from the first driving power VDD to the second driving power VSS via the light emitting element LD in response to a voltage of the first node N1.

The first transistor T1 may be formed as a double gate transistor including a first gate electrode and a second gate electrode. When the second gate electrode is connected to the second node N2, the gate-source voltage and the driving current of the first transistor T1 may be stabilized.

The second transistor T2 may be connected between the data line DLj and the first node N1. In addition, a gate electrode of the second transistor T2 may be connected to the first scan line SL1i. Thus, the second transistor T2 may be turned on when an enabled first scan signal GW (or a high-level first scan signal GW) is supplied to the first scan line SL1i, thereby electrically connecting the data line DLj and the first node N1.

The third transistor T3 may be connected between the second node N2 and the third node N3. The second node N2 refers to a node to which the second electrode of the first transistor T1 and a first electrode of the third transistor T3 are electrically connected, and the third node N3 refers to a node to which a first electrode of the light emitting element LD is connected. A gate electrode of the third transistor T3 may be connected to the second emission control line EL2i. Thus, the third transistor T3 may be turned off when a disabled second emission control signal EM2 (or a low-level second emission control signal EM2) is supplied to the second emission control line EL2i, and may be turned on in other cases (e.g., the third transistor T3 may be turned on when an enabled second emission control signal EM2 (or a high-level second emission control signal EM2) is supplied to the second emission control line EL2i).

The fourth transistor T4 may be connected between the third node N3 and the third power line PL3. In addition, a gate electrode of the fourth transistor T4 may be connected to the second scan line SL2i. Thus, the fourth transistor T4 may be turned on when an enabled second scan signal GI (or a high-level second scan signal GI) is supplied to the second scan line SL2i to electrically connect the third power line PL3 and the third node N3.

When the third power line PL3 and the third node N3 are electrically connected, the initialization voltage VINT from the third power line PL3 may be supplied to the third node N3. Then, the parasitic capacitor equivalently formed on the light emitting element LD may be discharged, thereby improving the black expression capability.

The fifth transistor T5 is connected between the fourth power line PL4 and the first node N1. In addition, a gate electrode of the fifth transistor T5 may be connected to the third scan line SL3i. Thus, the fifth transistor T5 may be turned on when an enabled third scan signal GR (or a high-level third scan signal GR) is supplied to the third scan line SL3i, thereby electrically connecting the fourth power line PL4 and the first node N1. The fourth power line PL4 and the first node N1 are electrically connected, and the reference voltage VREF may be supplied to the first node N1.

The sixth transistor T6 may be connected between the first power line PL1 and the first electrode of the first transistor T1. In addition, a gate electrode of the sixth transistor T6 may be connected to the first light emission control line EL1i. Thus, the sixth transistor T6 may be turned off when a disabled first emission control signal EM1 (or a low-level first emission control signal EM1) is supplied to the first emission control line EL1i, and may be turned on in other cases (e.g., the sixth transistor T6 may be turned on when an enabled first emission control signal EM1 (or a high-level first emission control signal EM1) is supplied to the first emission control line EL1i).

The first capacitor Cst may be connected between the first node N1 and the second node N2. The first capacitor Cst may store a voltage corresponding to the data signal.

The second capacitor Chold may be connected between the first power line PL1 and the second node N2. The second capacitor Chold may stabilize the voltage of the second node N2.

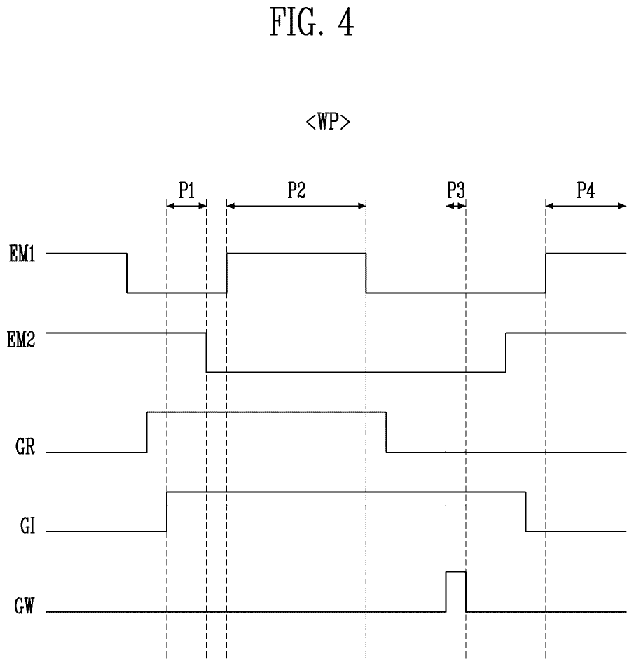

FIG. 4 is a waveform diagram illustrating a method of driving the pixel of FIG. 3 during a write period WP, according to one or more embodiments. The write period WP may be included in an active period of one frame.

Referring to FIGS. 3 and 4, the method of driving the pixel PXij may include a first period P1, a second period P2, a third period P3, and a fourth period P4.

The first period P1 may be a period for initializing the first capacitor Cst. The second period P2 may be a period for compensating a threshold voltage of the first transistor T1. The third period P3 may be a period during which the voltage corresponding to the data signal is stored in the pixel PXij. During the first period P1 to the third period P3, the light emitting element LD may be initialized. The fourth period P4 may be a period in which the pixel PXij (or the light emitting element LD) emits light.

During the first period P1, the enabled second scan signal GI may be supplied to the second scan line SL2i and an enabled third scan signal GR may be supplied to the third scan line SL3i. In addition, during the first period P1, the disabled first emission control signal EM1 may be supplied to the first emission control line EL1i, and an enabled second emission control signal EM2 (or a high level voltage) may be supplied to the second emission control line EL2i.

When the disabled first emission control signal EM1 is supplied to the first emission control line EL1i, the sixth transistor T6 may be turned off. When the sixth transistor T6 is turned off, the electrical connection between the first power line PL1 and the first transistor T1 may be cut off, and the light emitting element LD may be set to a non-emission state.

When the enabled second scan signal GI is supplied to the second scan line SL2i, the fourth transistor T4 is turned on. When the fourth transistor T4 is turned on, the initialization voltage VINT may be supplied to the third node N3. The enabled second scan signal GI supplied to the second scan line SL2i may be supplied during the first period P1 to the third period P3, and accordingly, the light emitting element LD may be initialized during the first period P1 to the third period P3.

When the enabling second emission control signal EM2 is supplied to the second emission control line EL2i, the third transistor T3 is turned on. When the third transistor T3 is turned on, the initialization voltage VINT may be supplied to second node N2.

When the enabled third scan signal GR is supplied to the third scan line SL3i, the fifth transistor T5 is turned on. When the fifth transistor T5 is turned on, the reference voltage VREF is supplied to the first node N1. When the reference voltage VREF is supplied to the first node N1 and the initialization voltage VINT is supplied to the second node N2, the first capacitor Cst and the second capacitor Chold may be initialized. That is, the first period P1 may be a period for initializing the pixel PXij so that the pixel PXij may not be affected by the data signal supplied in the previous frame.

During the second period P2, an enabled first emission control signal EM1 (or a high-level voltage) may be supplied to the first emission control line EL1i, and the enabled third scan signal GR may be supplied to the third scan line SL3i. The enabled third scan signal GR supplied to the third scan line SL3i may be supplied during the first period P1 and the second period P2.

When the enabled first emission control signal EM1 is supplied to the first emission control line EL1i, the sixth transistor T6 may be turned on, and accordingly, a voltage of the first driving power VDD may be supplied to the first electrode of the first transistor T1. When the enabled third scan signal GR is supplied to the third scan line SL3i, the fifth transistor T5 may be turned on, and the reference voltage VREF may be supplied to the first node N1 accordingly.

The reference voltage VREF is set such that the first transistor T1 may be turned on, and accordingly, a voltage of the second node N2 may be increased in response to the current supplied from the first transistor T1. For example, the voltage of the second node N2 may be raised to a value equal to the reference voltage VREF minus the absolute threshold voltage of the first transistor T1. In other words, during the second period P2, the first capacitor Cst may store a voltage corresponding to the threshold voltage of the first transistor T1.

A width of the second period P2 may be determined by the supply time of the enabled first emission control signal EM1 and the enabled third scan signal GR. In other words, in one or more embodiments of the present disclosure, the compensation time (i.e., the second period P2) of the threshold voltage of the first transistor T1 may be controlled using the supply time of the enabled first emission control signal EM1 and the enabled third scan signal GR.

During the second period P2, the disabled second emission control signal EM2 may be supplied to the second emission control line EL2i. When the disabled second emission control signal EM2 is supplied to the second emission control line EL2i, the third transistor T3 maintains a turn-off state. Thus, the second node N2 and the third node N3 may be electrically blocked during the second period P2.

During the third period P3, the disabled first emission control signal EM1 is supplied to the first emission control line EL1i, and the sixth transistor T6 is turned off accordingly. During the third period P3, the disabled second emission control signal EM2 is supplied to the second emission control line EL2i, and the third transistor T3 is turned off accordingly.

During the third period P3, the enabled first scan signal GW is supplied to the first scan line SL1i. When the enabled first scan signal GW is supplied to the first scan line SL1i, the second transistor T2 is turned on. When the second transistor T2 is turned on, a data signal from the data line DLj may be supplied to the first node N1.

During the third period P3, the voltages of the first node N1 and the second node N2 may be represented as shown in Equation 1.

$$VN 1 = Vdata \qquad Equation 1$$

$$VN 2 = VREF - Vth 1$$

In Equation 1, Vdata may represent the voltage of the data signal and Vth1 may represent the threshold voltage of the first transistor T1.

Although Equation 1 describes that the second node N2 maintains the voltage VREF-Vth1 during the third period P3 for ease of explanation, the present disclosure is not limited thereto.

For example, during the third period P3, the first node N1 may be changed from the reference voltage VREF to the voltage Vdata of the data signal, and the voltage of the second node N2 may also be changed by coupling of the first capacitor Cst. However, the voltage of the second node N2 may be changed in response to the ratio of the first capacitor Cst and the second capacitor Chold, and the amount of voltage change of the second node N2 may be reduced or minimized accordingly. Hereafter, for simplicity of explanation, it is assumed that during the third period P3, the second node N2 maintains the voltage VREF-Vth1.

The voltage stored in the first capacitor Cst during the third period P3 may be determined by the reference voltage VREF and the voltage Vdata of the data signal. For example, the pixel PXij may generate light of a suitable luminance (e.g., a predetermined luminance) based on the voltage difference between the reference voltage VREF and the voltage Vdata of the data signal. Because the reference voltage VREF is set to a constant voltage, it may be described that the luminance of the pixel PXij is determined by the voltage Vdata of the data signal.

During the fourth period P4, the enabled first emission control signal EM1 is supplied to the first emission control line EL1i. When the enabled first emission control signal EM1 is supplied to the first emission control line EL1i, the sixth transistor T6 is turned on. When the sixth transistor T6 is turned on, the first power line PL1 and the first transistor T1 may be electrically connected.

During the fourth period P4, the enabled second emission control signal EM2 is supplied to the second emission control line EL2i. When the enabled second emission control signal EM2 is supplied to the second emission control line EL2i, the third transistor T3 is turned on. When the third transistor T3 is turned on, the second node N2 and the third node N3 may be electrically connected.

During the fourth period P4, the first transistor T1 may supply a driving current corresponding to the voltage of the first node N1 from the first driving power VDD to the second driving power VSS via the light emitting element LD. During the fourth period P4, the light emitting element LD may generate light of a luminance corresponding to the driving current.

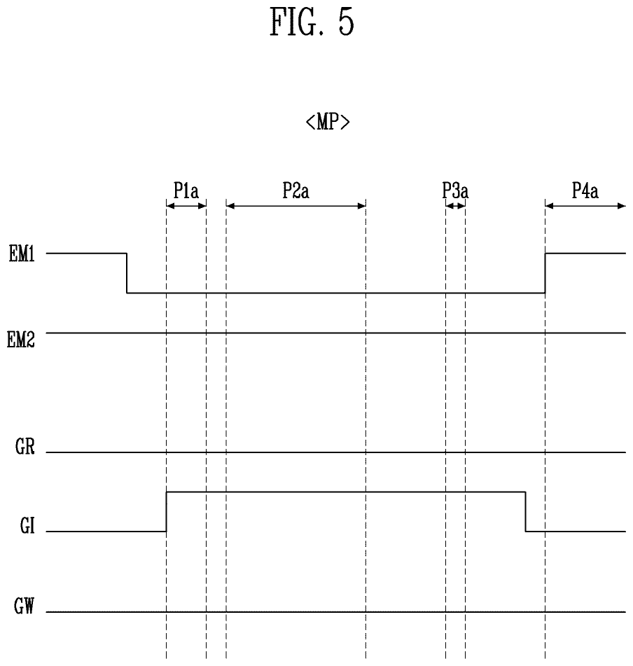

FIG. 5 is a waveform diagram illustrating a method for driving the pixel of FIG. 3 during a hold period, according to one or more embodiments.

Referring to FIG. 3-5, in one or more embodiments of the present disclosure, a frame may include one write period WP and at least one hold period MP.

The write period WP is a period during which a voltage of a data signal is stored in the pixels PX, and the driving signal of FIG. 4 may be supplied. That is, the write period WP may include a first period P1, a second period P2, a third period P3, and a fourth period P4 as shown in FIG. 4, and enabled first scan signals GW, GI, and GR and the disabled first emission control signals EM1 and EM2 may be supplied in the corresponding periods (at least one of P1 to P4).

The hold period MP is a period in which the pixels PX are set to a non-emission state for some period while the data signal supplied in the write period WP is maintained. One or more hold periods MP may be included in a frame. When the hold period MP is included in one frame, the pixels PX are set to a non-emission state at a suitable interval (e.g., a predetermined interval), and the video quality may be improved accordingly.

The hold period MP may include a first period P1a, a second period P2a, a third period P3a, and a fourth period P4a corresponding to the first period P1, the second period P2, the third period P3, and the fourth period P4 of FIG. 4, respectively, as shown in FIG. 5.

During the first period P1a to the third period P3a of the hold period MP, the disabled first emission control signal EM1 may be supplied to the first emission control line EL1i. When the disabled first emission control signal EM1 is supplied to the first emission control line EL1i, the sixth transistor T6 is turned off, and accordingly, the light emitting element LD may be set to a non-emission state during the first period P1a to the third period P3a.

During the first period P1a to the third period P3a of the hold period MP, the enabled second scan signal GI may be supplied to the second scan line SL2i. When the second scan signal GI is supplied to the second scan line SL2i, the fourth transistor T4 may be turned on, and the first electrode of the light emitting element LD may be initialized to the initialization voltage VINT accordingly.

During the fourth period P4a of the hold period MP, the enabled first emission control signal EM1 may be supplied to the first emission control line EL1i. When the enabled first emission control signal EM1 is supplied to the first emission control line EL1i, the sixth transistor T6 is turned on. When the sixth transistor T6 is turned on, the first power line PL1 and the first transistor T1 may be electrically connected.

The first transistor T1 may supply a driving current corresponding to the voltage of the first node N1 from the first driving power VDD to the second driving power VSS via the light emitting element LD. During the fourth period P4a, the light emitting element LD may generate light of a luminance corresponding to the driving current.

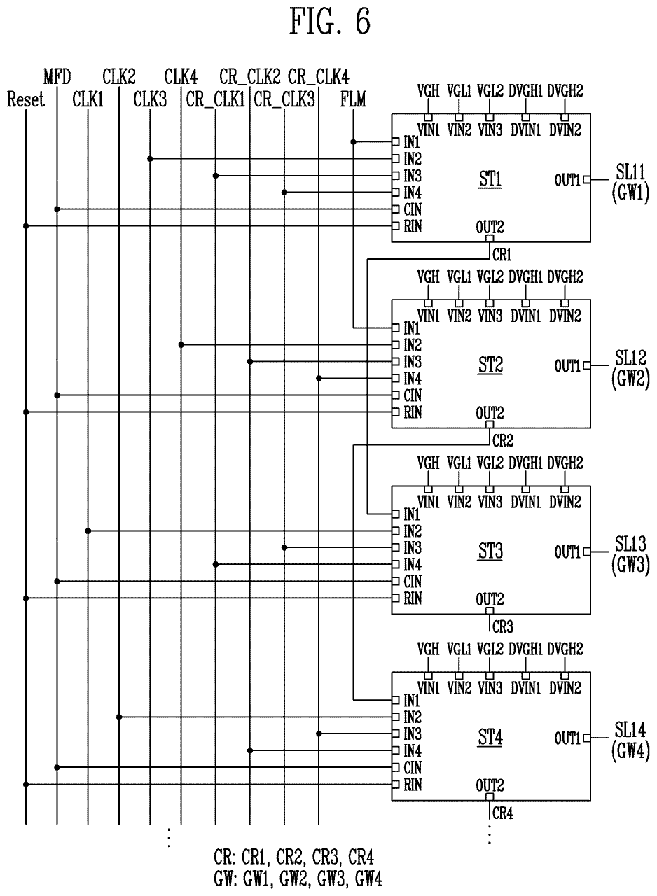

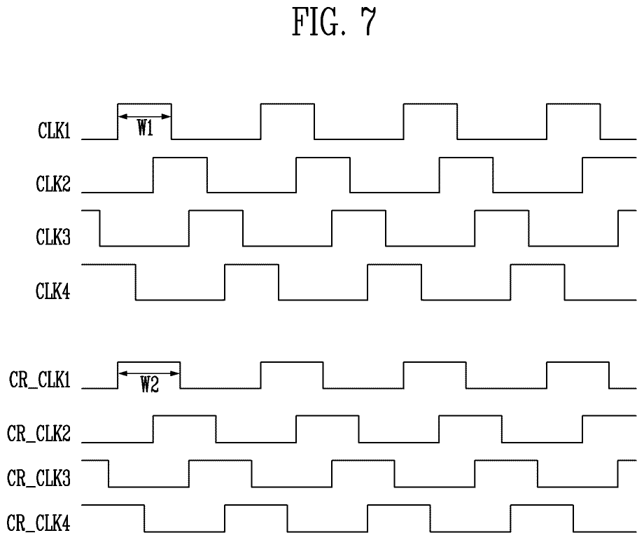

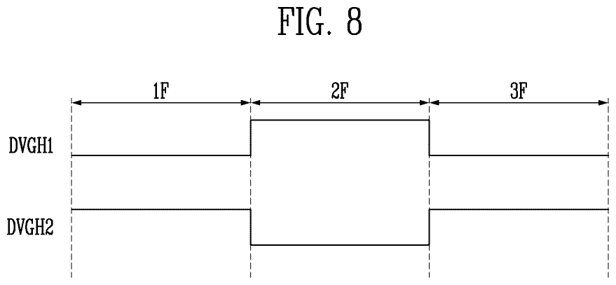

FIG. 6 is a block diagram illustrating the first scan driver 132 according to one or more embodiments of the present disclosure. FIG. 7 is a waveform diagram illustrating clock signals shown in FIG. 6, according to one or more embodiments of the present disclosure. FIG. 8 is a waveform diagram illustrating embodiments of the control power illustrated in FIG. 6. In FIG. 6, a start signal FLM may correspond to the first scan start signal FLM1 shown in FIG. 2.

Referring to FIG. 6, the first scan driver 132 according to one or more embodiments of the present disclosure may include a plurality of stage circuits ST1, ST2, ST3, ST4, . . . and so on. Each of the stage circuits ST1 to ST4 may be electrically coupled to one of the first scan lines SL11, SL12, SL13, and SL14.

For example, the first stage circuit ST1 may be electrically coupled to the first scan line SL11 and may supply an enabled first scan signal GW1 to the first scan line SL11. The second stage circuit ST2 may be electrically connected to the first scan line SL12, and may supply an enabled first scan signal GW2 to the first scan line SL12. The third stage circuit ST3 may be electrically connected to the first scan line SL13, and may supply an enabled first scan signal GW3 to the first scan line SL13. The fourth stage circuit ST4 may be electrically connected to the first scan line SL14, and may supply an enabled first scan signal GW4 to the first scan line SL14.

Each of the stage circuits ST1 to ST4 may have a first input terminal IN1, a second input terminal IN2, a third input terminal IN3, a fourth input terminal IN4, a control input terminal CIN, and a reset input terminal RIN. Further, each of the stage circuits ST1 to ST4 may have a first power input terminal VIN1, a second power input terminal VIN2, a third power input terminal VIN3, a first control power input terminal DVIN1, and a second control power input terminal DVIN2. Further, each of the stage circuits ST1 to ST4 may be provided with a first output terminal OUT1 and a second output terminal OUT2.

A start signal FLM or a carry signal CR of the previous stage circuit may be input to the first input terminal IN1. For example, the start signal FLM may be input to the first input terminal IN1 of the first stage circuit ST1 and the second stage circuit ST2. In one example, a carry signal CR1 of the previous odd-numbered stage circuit (i.e., the first stage circuit ST1) may be input to the first input terminal IN1 of the third stage circuit ST3 (or an odd-numbered stage circuit). In one example, the first input terminal IN1 of the fourth stage circuit ST4 (or an even-numbered stage circuit) may be input with a carry signal CR2 of the preceding even-numbered stage circuit (i.e., the second stage circuit ST2).

A first clock signal CLK1, a second clock signal CLK2, a third clock signal CLK3, or a fourth clock signal CLK4 may be input to the second input terminal IN2. For example, the third clock signal CLK3 may be input to the second input terminal IN2 of the first stage circuit ST1, the fourth clock signal CLK4 may be input to the second input terminal IN2 of the second stage circuit ST2, the first clock signal CLK1 may be input to the second input terminal IN2 of the third stage circuit ST3, and the second clock signal CLK2 may be input to the second input terminal IN2 of the fourth stage circuit ST4.

The first clock signal CLK1 and the fourth clock signal CLK4 may be signals with the same period and different phases, as shown in FIG. 7. For example, the second clock signal CLK2 may be 90 degrees out of phase with respect to the first clock signal CLK1. In one example, the third clock signal CLK3 may be 90 degrees out of phase with respect to the second clock signal CLK2 and 180 degrees out of phase with respect to the first clock signal CLK1. For example, the fourth clock signal CLK4 may be 90 degrees out of phase with respect to the third clock signal CLK3 and 270 degrees out of phase with respect to the first clock signal CLK1.

A first carry clock signal CR_CLK1 (or a carry clock signal), a second carry clock signal CR_CLK2, a third carry clock signal CR_CLK3, or a fourth carry clock signal CR_CLK4 may be input to the third input terminal IN3. For example, the first carry clock signal CR_CLK1 may be input to the third input terminal IN3 of the first stage circuit ST1, the second carry clock signal CR_CLK2 may be input to the third input terminal IN3 of the second stage circuit ST2, the third carry clock signal CR_CLK3 may be input to the third input terminal IN3 of the third stage circuit ST3, and the fourth carry clock signal CR_CLK4 may be input to the third input terminal IN3 of the fourth stage circuit ST4.

The first carry clock signal CR_CLK1 to the fourth carry clock signal CR_CLK4 may have the same period and different phases as shown in FIG. 7. For example, the second carry clock signal CR_CLK2 may be 90 degrees out of phase with respect to the first carry clock signal CR_CLK1. In one example, the third carry clock signal CR_CLK3 may be 90 degrees out of phase with respect to the second carry clock signal CR_CLK2 and 180 degrees out of phase with respect to the first carry clock signal CR_CLK1. For example, the fourth carry clock signal CR_CLK4 may be 90 degrees out of phase with respect to the third carry clock signal CR_CLK3 and 270 degrees out of phase with respect to the first carry clock signal CR_CLK1.

In one or more embodiments, the first clock signal CLK1 and the first carry clock signal CR_CLK1 may have the same period. A high voltage (or a logic high voltage) of the first clock signal CLK1 may have a first width W1, and the high voltage (or a logic high voltage) of the first carry clock signal CR_CLK1 may have a second width W2. In one or more embodiments, the second width W2 may be greater than the first width W1.

The first carry clock signal CR_CLK1, the second carry clock signal CR_CLK2, the third carry clock signal CR_CLK3, or the fourth carry clock signal CR_CLK4 may be input to the fourth input terminal IN4. For example, the third carry clock signal CR_CLK3 may be input to the fourth input terminal IN4 of the first stage circuit ST1, the fourth carry clock signal CR_CLK4 may be input to the fourth input terminal IN4 of the second stage circuit ST2, the first carry clock signal CR_CLK1 may be input to the fourth input terminal IN4 of the third stage circuit ST3, and the second carry clock signal CR_CLK2 may be input to the fourth input terminal IN4 of the fourth stage circuit ST4.

A frequency control signal MFD may be input to the control input terminal CIN. The frequency control signal MFD is a global signal and may be input to all stage circuits ST1 to ST4 in common. The stage circuits ST1 to ST4 may control whether to output the first scan signal GW (or a scan signal) in response to the frequency control signal MFD.

A reset signal Reset may be input to the reset input terminal RIN. The reset signal Reset is a global signal and may be input to all stage circuits ST1 to ST4 in common. The stage circuits ST1 to ST4 may be initialized to a desired state (e.g., a predetermined state) when the reset signal Reset is input.

A first power VGH (or a logic high voltage) may be input to the first power input terminal VIN1 (or a high power input terminal). The first power VGH may have a high voltage (or a logic high voltage).

A second power VGL1 (or a first logic low voltage) may be input to the second power input terminal VIN2 (or a first low power input terminal). The second power VGL1 may have a low voltage (or a logic low voltage).

A third power VGL2 (or a second logic low voltage) may be input to the third power input terminal VIN3 (or a second low power input terminal). The third power VGL2 may have a low voltage (or a logic low voltage). The second power VGL1 may have a high voltage relative to the third power VGL2, but the present disclosure is not limited thereto. For example, the second power VGL1 may be set to the same voltage as the third power VGL2, and the third power input terminal VIN3 may be omitted.

A first control power DVGH1 may be input to the first control power input terminal DVIN1.

A second control power DVGH2 may be input to the second control power input terminal DVGH2. The first control power DVGH1 and the second control power DVGH2 alternately repeat a high voltage (or a logic high voltage) and a low voltage (or a logic low voltage) on a frame-by-frame basis as shown in FIG. 8, and the high voltage of the first control power DVGH1 and the high voltage of the second control power DVGH2 may not overlap. For example, the first control power DVGH1 may have a high voltage during a second frame 2F, and the second control power DVGH2 may have a high voltage during a first frame 1F and a third frame 3F. However, the present disclosure is not limited thereto, and the first control power DVGH1 and the second control power DVGH2 may alternately repeat the high and low voltages in units of a plurality of frames.

The first output terminal OUT1 may output a scan signal GW. Each of the first output terminals OUT1 may be electrically connected to one of the first scan lines SL11 to SL14.

The second output terminal OUT2 may output the carry signal CR.

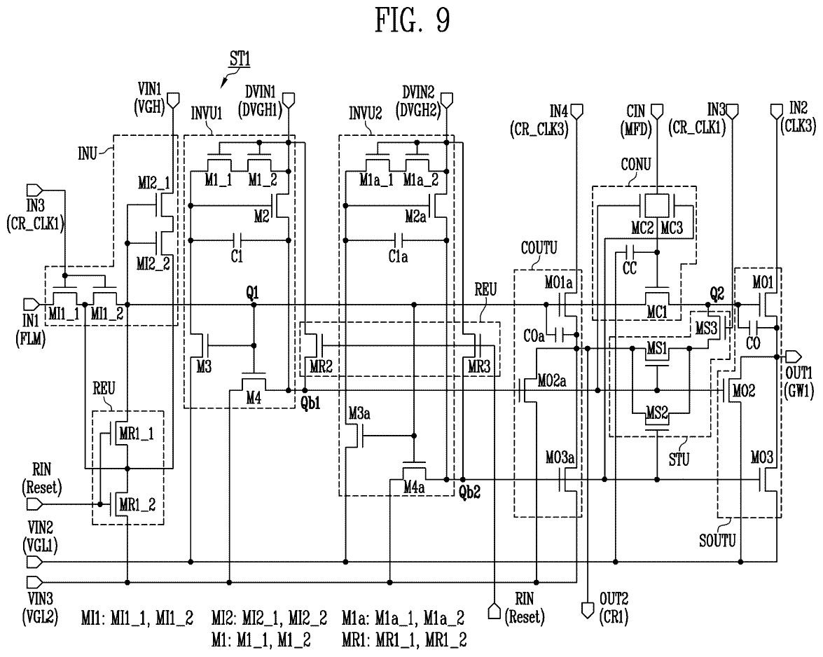

FIG. 9 is a schematic circuit diagram illustrating a stage circuit as shown in FIG. 6, according to one or more embodiments. In FIG. 9, the first stage circuit ST1 is shown for convenience of explanation, but the remaining stage circuits ST2 to ST4 may be composed of substantially the same circuit as the first stage circuit ST1.

Referring to FIG. 9, the stage circuit ST1 according to one or more embodiments of the present disclosure may include an input part INU, a first inverter part INVU1, a second inverter part INVU2, a carry output part COUTU, a scan output part SOUTU, a control part CONU, a reset part REU, and a stabilizing part STU. The stage circuit ST1 according to one or more embodiments of the present disclosure may be configured in various forms so as to include a control part CONU.

The input part INU may be connected to a first input terminal IN1, a third input terminal IN3, and a first power input terminal VIN1. The input part INU may control the electrical connection of the first input terminal IN1 and a first control node Q1 in response to the first carry clock signal CR_CLK1 input to the third input terminal IN3. The input part INU may include a first input transistor MI1 and a second input transistor MI2.

The first input transistor MI1 may be connected between the first input terminal IN1 and the first control node Q1. The first input transistor MI1 may include the plurality of transistors MI1_1 and MI1_2 connected in series. A gate electrode of the first input transistor MI1 may be connected to the third input terminal IN3. Thus, the first input transistor MI1 may be turned on when the first carry clock signal CR_CLK1 is input to the third input terminal IN3, thereby electrically connecting the first input terminal IN1 and the first control node Q1.

The input of the first carry clock signal CR_CLK1 (or the supply of the first carry clock signal CR_CLK1) may mean that a gate-on voltage (e.g., a logic high voltage) for turning on the first input transistor MI1 is supplied to the third input terminal IN3. In the following description, the input or supplying of the carry signals CR_CLK1 to CR_CLK4 or the clock signals CLK1 to CLK4 may mean that a gate-on voltage is input to at least one corresponding input terminal IN2, IN3, or IN4.

The second input transistor MI2 may be connected between the first power input terminal VIN1 and a common terminal of the first transistors MI1_1 and MI1_2. The second input transistor MI2 may include a plurality of transistors MI2_1 and MI2_2 connected in series. A gate electrode of the second input transistor MI2 may be connected to the first control node Q1. The second input transistor MI2 may control the electrical connection between the first power input terminal VIN1 and a common terminal of the first transistors MI1_1 and MI1_2 in response to the voltage of the first control node Q1.

The first inverter part INVU1 may be connected to the first control power input terminal DVIN1, the second power input terminal VIN2, and the third power input terminal VIN3. The first inverter part INVU1 may control a voltage of a first driving node Qb1 in response to the voltage of the first control node Q1. The first inverter part INVU1 may include a first transistor M1, a second transistor M2, a third transistor M3, a fourth transistor M4, and a first capacitor C1.

The first transistor M1 may be connected between the first control power input terminal DVIN1 and a gate electrode of the second transistor M2. The first transistor M1 may be configured with a plurality of transistors M1_1 and M1_2 connected in series. A gate electrode of the first transistor M1 may be connected to the first control power input terminal DVIN1. The first transistor M1 is connected in the form of a diode (e.g., the first transistor M1 may be diode-connected) to allow current to flow from the first control power input terminal DVIN1 to the gate electrode of the second transistor M2.

The second transistor M2 may be connected between the first control power input terminal DVIN1 and the first driving node Qb1. The gate electrode of the second transistor M2 may be connected to the first control power input terminal DVIN1 via the first transistor M1. The second transistor M2 is connected in the form of a diode (e.g., the second transistor M2 may be diode-connected) to allow current to flow from the first control power input terminal DVIN1 to the first driving node Qb1.

The first transistor M1 and the second transistor M2 may be turned on when a first control power DVGH1 of a logic high voltage is input to the first control power input terminal DVIN1, thereby electrically connecting the first control power input terminal DVIN1 and the first driving node Qb1.

The third transistor M3 may be connected between the gate electrode of the second transistor M2 and the second power input terminal VIN2. A gate electrode of the third transistor M3 may be connected to the first control node Q1. The third transistor M3 may be turned on or off in response to the voltage of the first control node Q1.

The fourth transistor M4 may be connected between the first driving node Qb1 and the third power input terminal VIN3. A gate electrode of the fourth transistor M4 may be connected to the first control node Q1. The fourth transistor M4 may be turned on or off in response to the voltage of the first control node Q1.

The first capacitor C1 may be connected between the gate electrode of the second transistor M2 and the first driving node Qb1.

The second inverter part INVU2 may be connected to the second control power input terminal DVIN2, the second power input terminal VIN2, and the third power input terminal VIN3. The second inverter part INVU2 may control a voltage of a second driving node Qb2 in response to the voltage of the first control node Q1.

The second inverter part INVU2 may include a first transistor M1a, a second transistor M2a, a third transistor M3a, a fourth transistor M4a, and a first capacitor C1a.

The first transistor M1a may be connected between the second control power input terminal DVIN2 and a gate electrode of the second transistor M2a. The first transistor M1a may be configured with a plurality of transistors M1a_1 and M1a_2 connected in series. A gate electrode of the first transistor M1a may be connected to the second control power input terminal DVIN2. The first transistor M1a is connected in the form of a diode (e.g., the first transistor M1a may be diode-connected) to allow current to flow from the second control power input terminal DVIN2 to the gate electrode of the second transistor M2a.

The second transistor M2a may be connected between the second control power input terminal DVIN2 and the second driving node Qb2. The gate electrode of the second transistor M2a may be connected to the second control power input terminal DVIN2 via the first transistor M1a. The second transistor M2a is connected in the form of a diode (e.g., the second transistor M2a may be diode-connected) to allow current to flow from the second control power input terminal DVIN2 to the second driving node Qb2.

The first transistor M1a and the second transistor M2a may be turned on when a second control power DVGH2 of a logic high voltage is input to the second control power input terminal DVIN2, thereby electrically connecting the second control power input terminal DVIN2 and the second driving node Qb2.

The third transistor M3a may be connected between the gate electrode of the second transistor M2a and the second power input terminal VIN2. A gate electrode of the third transistor M3a may be connected to the first control node Q1. The third transistor M3a may be turned on or off in response to the voltage of the first control node Q1.

The fourth transistor M4a may be connected between the second driving node Qb2 and the third power input terminal VIN3. A gate electrode of the fourth transistor M4a may be connected to the first control node Q1. The fourth transistor M4a may be turned on or off in response to the voltage of the first control node Q1.

The first capacitor C1a may be connected between the gate electrode of the second transistor M2a and the second driving node Qb2.

The first inverter part INVU1 and the second inverter part INVU2 may be alternately driven on a frame-by-frame basis in response to the voltages of the first control power DVGH1 and the second control power DVGH2 repeating high and low voltages alternately on a frame-by-frame basis. For example, the first inverter part INVU1 and the second inverter part INVU2 may be alternately driven on a frame-by-frame basis so as to control the voltages of the first driving node Qb1 and the second driving node Qb2.

The carry output part COUTU may be connected to the fourth input terminal IN4, the third power input terminal VIN3, and the second output terminal OUT2. The carry output part COUTU may output the carry signal CR1 to the second output terminal OUT2 in response to the voltage of the first control node Q1. The carry output part COUTU may be provided with a first output transistor MO1a, a second output transistor MO2a, a third output transistor MO3a, and an output capacitor COa.

The first output transistor MO1a may be connected between the fourth input terminal IN4 and the second output terminal OUT2. A gate electrode of the first output transistor MO1a may be connected to the first control node Q1. Thus, the first output transistor MO1a may be turned on or off in response to the voltage of the first control node Q1, thereby controlling the electrical connection of the fourth input terminal IN4 and the second output terminal OUT2.

The second output transistor MO2a may be connected between the second output terminal OUT2 and the third power input terminal VIN3. A gate electrode of the second output transistor MO2a may be connected to the first driving node Qb1. The second output transistor MO2a may be turned on or off in response to the voltage of the first driving node Qb1, thereby controlling the electrical connection of the second output terminal OUT2 and the third power input terminal VIN3.

The third output transistor MO3a may be connected between the second output terminal OUT2 and the third power input terminal VIN3. A gate electrode of the third output transistor MO3a may be connected to the second driving node Qb2. The third output transistor MO3a may be turned on or off in response to a voltage of the second driving node Qb2, thereby controlling the electrical connection between the second output terminal OUT2 and the third power input terminal VIN3.

The output capacitor COa may be connected between the first control node Q1 and the second output terminal OUT2. The output capacitor COa may control the voltage of the first control node Q1 in response to a voltage of the second output terminal OUT2.

The second output transistor MO2a may be driven under the control of the first driving node Qb1, i.e., the first inverter INVU1. The third output transistor MO3a may be driven under the control of the second driving node Qb2, i.e., the second inverter INVU2. The second output transistor MO2a and the third output transistor MO3a may be alternately driven on a frame-by-frame basis, thereby ensuring the durability of the transistors MO2a and MO3a.

The scan output part SOUTU may be connected to the second input terminal IN2, the second power input terminal VIN2, and the first output terminal OUT1. The scan output part SOUTU may output a scan signal (e.g., the enabled first scan signal GW1) to the first output terminal OUT1 in response to a voltage of the second control node Q2. The scan output part SOUTU may include a first output transistor MO1, a second output transistor MO2, a third output transistor MO3, and an output capacitor CO.

The first output transistor MO1 may be connected between the second input terminal IN2 and the first output terminal OUT1. A gate electrode of the first output transistor MO1 may be connected to the second control node Q2. Thus, the first output transistor MO1 may be turned on or off in response to the voltage of the second control node Q2, thereby controlling the electrical connection of the second input terminal IN2 and the first output terminal OUT1.

The second output transistor MO2 may be connected between the first output terminal OUT1 and the second power input terminal VIN2. A gate electrode of the second output transistor MO2 may be connected to the first driving node Qb1. Thus, the second output transistor MO2 may be turned on or off in response to the voltage of the first driving node Qb1, thereby controlling the electrical connection between the first output terminal OUT1 and the second power input terminal VIN2.

The third output transistor MO3 may be connected between the first output terminal OUT1 and the second power input terminal VIN2. A gate electrode of the third output transistor MO3 may be connected to the second driving node Qb2. Thus, the third output transistor MO3 may be turned on or off in response to the voltage of the second driving node Qb2, thereby controlling the electrical connection between the first output terminal OUT1 and the second power input terminal VIN2.

The second output transistor MO2 may be driven under the control of the first driving node Qb1, i.e., the first inverter INVU1. The third output transistor MO3 may be driven under the control of the second driving node Qb2, i.e., the second inverter INVU2. The second output transistor MO2 and the third output transistor MO3 may be driven alternately on a frame-by-frame basis, thereby ensuring the durability of the transistors MO2 and MO3.

The output capacitor CO may be connected between the second control node Q2 and the first output terminal OUT1. The output capacitor CO may control the voltage of the second control node Q2 in response to the voltage of the first output terminal OUT1.

The control part CONU may be connected to the control input terminal CIN. The control part CONU may control the electrical connection of the first control node Q1 and the second control node Q2 in response to the frequency control signal MFD input to the control input terminal CIN. The control part CONU may include a first control transistor MC1, a second control transistor MC2, a third control transistor MC3, and a control capacitor CC.

The first control transistor MC1 may be connected between the first control node Q1 and the second control node Q2.

The second control transistor MC2 and the third control transistor MC3 may be connected in parallel between a gate electrode of the first control transistor MC1 and the control input terminal CIN. A gate electrode of the second control transistor MC2 may be connected to the first driving node Qb1. A gate electrode of the third control transistor MC3 may be connected to the second driving node Qb2.

The second control transistor MC2 may be driven under the control of the first driving node Qb1, i.e., the first inverter INVU1. The third control transistor MC3 may be driven under the control of the second driving node Qb2, i.e., the second inverter INVU2. The second control transistor MC2 and the third control transistor MC3 may be driven alternately on a frame-by-frame basis, thereby ensuring the durability of the transistors MC2 and MC3.

The control capacitor CC may be connected between the gate electrode of the first control transistor MC1 and the second power input terminal VIN2. The control capacitor CC may store a suitable voltage (e.g., a predetermined voltage) corresponding to the frequency control signal MFD.

The reset part REU may be connected to the reset input terminal RIN, the first control power input terminal DVIN1, and the second control power input terminal DVIN2. The reset part REU may initialize the first control node Q1, the first driving node Qb1, and the second driving node Qb2 to a desired state (e.g., a predetermined state). The reset part REU may include a first reset transistor MR1, a second reset transistor MR2, and a third reset transistor MR3.

The first reset transistor MR1 may be connected between the first control node Q1 and the third power input terminal VIN3. The first reset transistor MR1 may be configured with a plurality of transistors MR1_1 and MR1_2 connected in series, and a common node between the plurality of transistors MR1_1 and MR1_2 may be connected to the second input transistor MI2. A gate electrode of the first reset transistor MR1 may be connected to the reset input terminal RIN. The first reset transistor MR1 may be turned on when the reset signal Reset is input to the reset input terminal RIN to supply a voltage of the third power VGL2 (or a low voltage) to the first control node Q1.

The second reset transistor MR2 may be connected between the first control power input terminal DVIN1 and the first driving node Qb1. A gate electrode of the second reset transistor MR2 may be connected to the reset input terminal RIN.

The third reset transistor MR3 may be connected between the second control power input terminal DVIN2 and the second driving node Qb2. A gate electrode of the third reset transistor MR3 may be connected to the reset input terminal RIN.

The first control power DVGH1 and/or the second control power DVGH2 may maintain a high voltage during a period when the reset signal Reset is input to the reset input terminal RIN. When the reset signal Reset is input to the reset input terminal RIN, the second reset transistor MR2 and/or the third reset transistor MR3 may be turned on, and a high voltage may be supplied to the first driving node Qb1 and/or the second driving node Qb2 accordingly.

The stabilization part STU may be connected to the third input terminal IN3. The stabilization part STU may supply a voltage of the third power VGL2 to the second driving node Q2 when the first carry clock signal CR_CLK1 is input to the third input terminal IN3. The stabilization part STU may include a first stabilization transistor MS1, a second stabilization transistor MS2, and a third stabilization transistor MS3.

The first stabilization transistor MS1 and the second stabilization transistor MS2 may be connected in parallel between the second output terminal OUT2 and a first electrode of the third stabilization transistor MS3. A gate electrode of the first stabilization transistor MS1 may be connected to the first driving node Qb1, and a gate electrode of the second stabilization transistor MS2 may be connected to the second driving node Qb2.

The first stabilization transistor MS1 may be driven under the control of the first driving node Qb1, i.e., the first inverter INVU1. The second stabilization transistor MS2 may be driven under the control of the second driving node Qb2, i.e., the second inverter INVU2. The first stabilization transistor MS1 and the second stabilization transistor MS2 may be driven alternately on a frame-by-frame basis, thereby ensuring the durability of the transistors MS1 and MS2.

The first electrode of the third stabilization transistor MS3 may be connected to the first stabilization transistor MS1 and the second stabilization transistor MS2, and a second electrode thereof may be connected to the second control node Q2. A gate electrode of the third stabilization transistor MS3 may be connected to the third input terminal IN3. The third stabilization transistor MS3 may be turned on when the first carry clock signal CR_CLK1 is input to the third input terminal IN3.

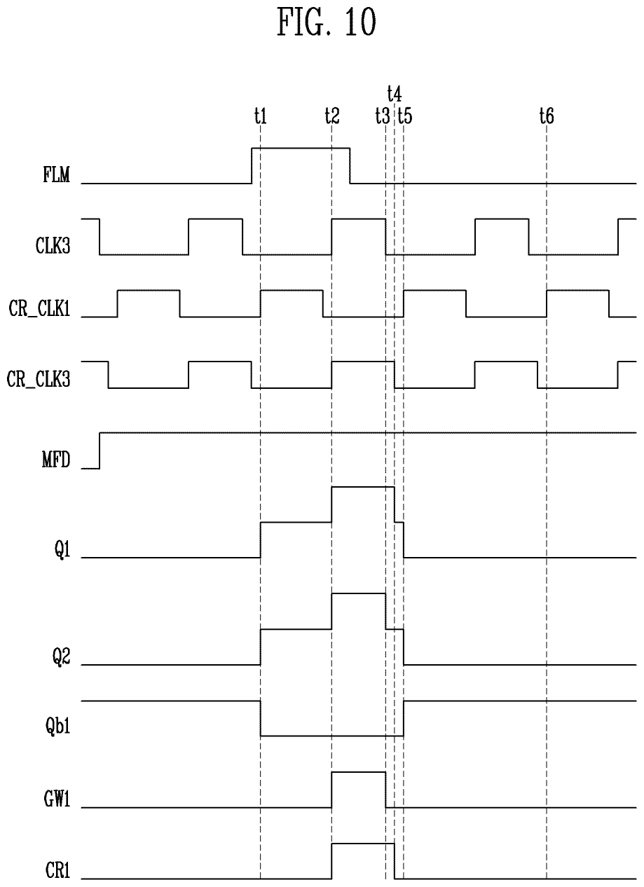

FIG. 10 is a waveform diagram illustrating a method of driving a stage circuit as shown in FIG. 9, according to one or more embodiments. When a description is made with reference to FIG. 10, it is assumed that the first control power DVGH1 is maintained at a high voltage, and the first inverter part INVU1 is driven accordingly. Referring to FIG. 10, it is assumed that the frequency control signal MFD is maintained at a high voltage (or a first level).

When the first control power DVGH1 is set to the high voltage, the first transistor M1, which is connected in the form of a diode, may be turned on during a period before a first time t1. Then, in response to the turn-on of the first transistor M1, the second transistor M2 connected in the diode form may be turned on.

When the second transistor M2 is turned on, the high voltage may be input to the first driving node Qb1. When the high voltage is input to the first driving node Qb1, the second control transistor MC2 may be turned on. When the second control transistor MC2 is turned on, the frequency control signal MFD of the high voltage is supplied to the gate electrode of the first control transistor MC1, and the first control transistor MC1 may be turned on accordingly. In addition, the high voltage corresponding to the turn-on of the first control transistor MC1 may be stored in the control capacitor CC.

At the first time t1, the start signal FLM of the high voltage may be input to the first input terminal IN1, and the first carry clock signal CR_CLK1 may be input to the third input terminal IN3. When the first carry clock signal CR_CLK1 is input to the third input terminal IN3, the first input transistor MI1 may be turned on. When the first input transistor MI1 is turned on, the high-voltage start signal FLM may be supplied to the first control node Q1.

When a high voltage is input to the first control node Q1, the third transistors M3 and M3a and the fourth transistors M4 and M4a may be turned on. When the third transistors M3 and M3a are turned on, the voltage from the second power source VGL1 (or a first logic low voltage) is supplied to the gate electrodes of the second transistors M2 and M2a, and the second transistors M2 and M2a may be turned off. When the fourth transistors M4 and M4a are turned on, a voltage of the third power VGL2 (or a low voltage) may be supplied to the first driving node Qb1 and the second driving node Qb2.

When a low voltage is input to the first driving node Qb1, the second output transistors MO2 and MO2a, the first stabilization transistor MS1, and the second control transistor MC2 may be turned off. When the low driving voltage is input to the second driving node Qb2, the third output transistors MO3 and MO3a, the second stabilization transistor MS2, and the third control transistor MC3 may be turned off.

Even when the second control transistor MC2 and the third control transistor MC3 are turned off, the first control transistor MC1 may maintain the turn-on state by the voltage stored in the control capacitor CC. Therefore, the high voltage supplied to the first control node Q1 may be supplied to the second control node Q2 via the first control transistor MC1.

When the first control node Q1 and the second control node Q2 are set to the high voltage, the first output transistors MO1 and MO1a may be turned on.

At a second time t2, the third clock signal CLK3 may be input (i.e., the high voltage is input) to the second input terminal IN2, and the third carry clock signal CR_CLK3 may be input (i.e., the high voltage is input) to the fourth input terminal IN4.

The third clock signal CLK3 input to the second input terminal IN2 may be supplied to the first output terminal OUT1 via the first output transistor MO1. The high-voltage third clock signal CLK3 supplied to the first output terminal OUT1 may be supplied to the first scan line SL11 as the enabled first scan signal GW1. The voltage of the second control node Q2 may be increased by boosting of the output capacitor CO, and the first output transistor MO1 may remain in the turn-on state.

The third carry clock signal CR_CLK3 input to the fourth input terminal IN4 may be supplied to the second output terminal OUT2 via the first output transistor MO1a. The high-voltage third carry clock signal CR_CLK3 supplied to the second output terminal OUT2 may be supplied to the next stage circuit (e.g., the third stage circuit ST3) as the carry signal CR1. The voltage of the first control node Q1 may be raised by boosting of the output capacitor COa, and the first output transistor MO1a may stably remain in the turn-on state accordingly.

At a third time t3, the supply of the third clock signal CLK3 to the second input terminal IN2 is interrupted (or a low voltage is supplied), and the voltage of the second control node Q2 may fall accordingly. Further, the supply of the enabled first scan signal GW1 to the first output terminal OUT1 may be interrupted.

At a fourth time t4, the supply of the third carry clock signal CR_CLK3 to the fourth input terminal IN4 may be interrupted (or a low voltage may be supplied), and the voltage of the first control node Q1 may be lowered accordingly. Further, the supply of the carry signal CR1 to the second output terminal OUT2 may be interrupted.

At a fifth time t5, the start signal FLM of a low voltage may be input to the first input terminal IN1, and the first carry clock signal CR_CLK1 may be input to the third input terminal IN3. When the first carry clock signal CR_CLK1 is input to the third input terminal IN3, the first input transistor MI1 may be turned on. When the first input transistor MI1 is turned on, the low-voltage start signal FLM may be supplied to the first control node Q1.

When a low voltage is input to the first control node Q1, the third transistors M3 and M3a and the fourth transistors M4 and M4a may be turned off. When the third transistor M3 and the fourth transistor M4 are turned off, a voltage of the first control power DVGH1 (i.e., a high voltage) may be input to the first driving node Qb1 by the second transistor M2 connected in the form of a diode.

When a high voltage is input to the first driving node Qb1, the second output transistors MO2 and MO2a, the first stabilization transistor MS1, and the second control transistor MC2 may be turned on. When the second output transistor MO2 is turned on, the voltage from the second power VGL1 may be supplied to the first output terminal OUT1. When the second output transistor MO2a is turned on, the voltage of the third power VGL2 may be supplied to the second output terminal OUT2.

When the second control transistor MC2 is turned on, the first control transistor MC1 may be turned on by the high-voltage frequency control signal MFD. Thus, the low voltage supplied to the first control node Q1 may be supplied to the second control node Q2 via the first control transistor MC1.

When the first control node Q1 and the second control node Q2 are set to the low voltage, the first output transistors MO1 and MO1a may be turned off.

At a sixth time t6, the first carry clock signal CR_CLK1 may be input to the third input terminal IN3, and the third stabilization transistor MS3 may be turned on accordingly. Because the first stabilization transistor MS1 and the second output transistor MO2a are set to the turn-on state, the voltage of the third power VGL2 may be supplied to the second control node Q2. In addition, because the first control transistor MC1 is turned on, the voltage of the third supply VGL2 may also be supplied to the first control node Q1.

The first control node Q1 and the second control node Q2 are initialized to the low voltage (i.e., the voltage of the third power VGL2) each time the first carry clock signal CR_CLK1 is input, and accordingly, the first output transistors MO1 and MO1a may be stably maintained in a turn-off state.

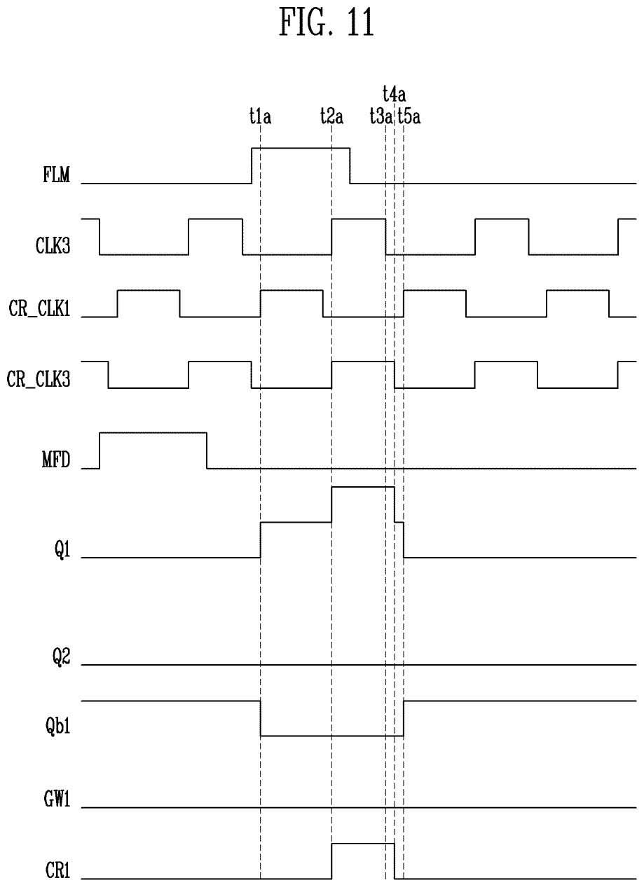

FIG. 11 is a waveform diagram illustrating a method of driving a stage circuit as shown in FIG. 9, according to one or more embodiments. When a description is made with reference to FIG. 11, it is assumed that the first control power DVGH1 maintains a high voltage, and the first inverter part INVU1 is driven accordingly. Referring to FIG. 11, it is assumed that the frequency control signal MFD is maintained at a low voltage (or a second level). In the following description with reference to FIG. 11, portions that are redundant with the description with reference to FIG. 10 may be omitted or briefly described.

Referring to FIG. 11, the first driving node Qb1 may be set to a high voltage during a period prior to a first time t1a. When the high voltage is input to the first driving node Qb1, the second control transistor MC2 may be turned on. When the second control transistor MC2 is turned on, the frequency control signal MFD of the low voltage is supplied to the gate electrode of the first control transistor MC1, and the first control transistor MC1 may be turned off accordingly. In addition, the low voltage corresponding to the turn-off of the first control transistor MC1 may be stored in the control capacitor CC.

At the first time t1a, the start signal FLM of a high voltage may be input to the first input terminal IN1, and the first carry clock signal CR_CLK1 may be input to the third input terminal IN3. When the first carry clock signal CR_CLK1 is input to the third input terminal IN3, the first input transistor MI1 may be turned on. When the first input transistor MI1 is turned on, the high-voltage start signal FLM may be supplied to the first control node Q1.

When a high voltage is input to the first control node Q1, the third transistors M3 and M3a and the fourth transistors M4 and M4a may be turned on. When the third transistors M3 and M3a are turned on, a voltage from the second power source VGL1 is supplied to the gate electrodes of the second transistors M2 and M2a, and the second transistors M2 and M2a may be turned off accordingly. When the fourth transistors M4 and M4a are turned on, a voltage of the third power VGL2 (or a low voltage) may be supplied to the first driving node Qb1 and the second driving node Qb2.

When a low voltage is input to the first driving node Qb1, the second output transistors MO2 and MO2a, the first stabilization transistor MS1, and the second control transistor MC2 may be turned off. When a low voltage is input to the second driving node Qb2, the third output transistors MO3 and MO3a, the second stabilization transistor MS2, and the third control transistor MC3 may be turned off.

Even when the second control transistor MC2 and the third control transistor MC3 are turned off, the first control transistor MC1 may remain turned off by the voltage stored in the control capacitor CC. Therefore, the high voltage supplied to the first control node Q1 is not transmitted to the second control node Q2. In other words, the first control node Q1 may have a high voltage and the second control node Q2 may have a low voltage.

When the first control node Q1 is set to the high voltage, the first output transistor MO1a may be turned on. When the second control node Q2 is set to a low voltage, the first output transistor MO1 may be turned off.

At a second time t2a, the third clock signal CLK3 may be input (i.e., a high voltage is input) to the second input terminal IN2, and the third carry clock signal CR_CLK3 may be input (i.e., a high voltage is input) to the fourth input terminal IN4.

Because the first output transistor MO1 is set to the turn-off state, the third clock signal CLK3 input to the second input terminal IN2 cannot be supplied to the first output terminal OUT1. In other words, the first output terminal OUT1 may maintain a low voltage.

Because the first output transistor MO1a is set to the turn-on state, the third carry clock signal CR_CLK3 input to the fourth input terminal IN4 may be supplied to the second output terminal OUT2. The high-voltage third carry clock signal CR_CLK3 supplied to the second output terminal OUT2 may be supplied to the next stage circuit (e.g., the third stage circuit ST3) as the carry signal CR1. The voltage of the first control node Q1 may be raised by boosting of the output capacitor COa, and the first output transistor MO1a may stably remain in the turn-on state accordingly.

At a third time t3a, the supply of the third clock signal CLK3 to the second input terminal IN2 may be interrupted (or a low voltage may be supplied).

At a fourth time t4a, the supply of the third carry clock signal CR_CLK3 to the fourth input terminal IN4 may be interrupted (or a low voltage may be supplied), and the voltage of the first control node Q1 may be lowered accordingly. Further, the supply of the carry signal CR1 to the second output terminal OUT2 may be interrupted.

At a fifth time t5a, the start signal FLM of a low voltage may be input to the first input terminal IN1, and the first carry clock signal CR_CLK1 may be input to the third input terminal IN3. When the first carry clock signal CR_CLK1 is input to the third input terminal IN3, the first input transistor MI1 may be turned on. When the first input transistor MI1 is turned on, the low-voltage start signal FLM may be supplied to the first control node Q1. When the low voltage is supplied to the first control node Q1, the first driving node Qb1 may have a high voltage.

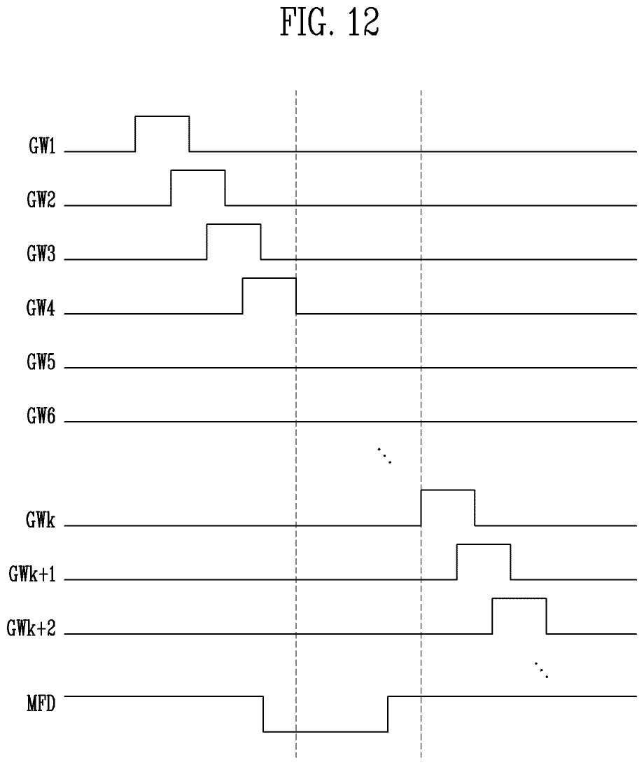

FIG. 12 is a waveform diagram indicating whether a scan signal corresponding to a frequency control signal is output, according to one or more embodiments.

Referring to FIG. 12, the first scan driver 132 (e.g., see FIG. 2) according to one or more embodiments of the present disclosure may control whether or not to output first scan signals (GW1, GW2, GW3, GW4, GW5, GW6, . . . , GWk, GWk+1, and GWk+2) in response to the frequency control signal MFD.

For example, the first scan driver 132 may sequentially output the enabled first scan signals GW1 to GW4 in response to the frequency control signal MFD of the high voltage. In addition, the first scan driver 132 may not output the first scan signals GW5, GW6, . . . (or may output a disabled first scan signal) in response to the frequency control signal MFD of the low voltage. In addition, the first scan driver 132 may sequentially output the enabled first scan signals GWk, GWk+1, GWk+2, . . . in response to the frequency control signal MFD of the high voltage.

As described above, the first scan driver 132 according to one or more embodiments of the present disclosure may control whether or not to output the first scan signals GW1 to GWk+2, . . . by each region of the display panel 110, so that at least two regions of the display panel 110 may be driven at different driving frequencies.

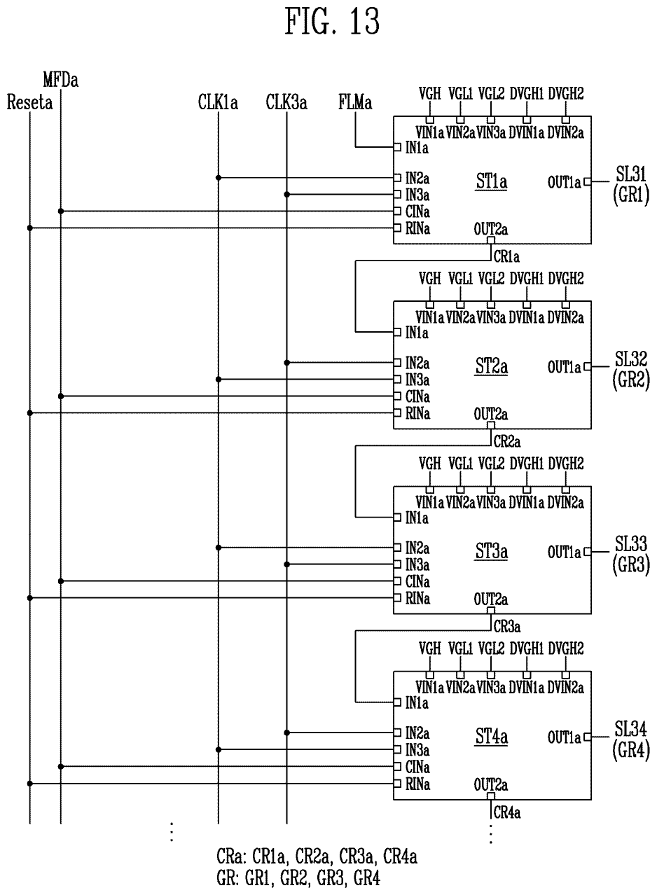

FIG. 13 is a block diagram illustrating the third scan driver 136 according to one or more embodiments of the present disclosure. In FIG. 13, a start signal FLMa may correspond to the third scan start signal FLM3 shown in FIG. 2.

Referring to FIG. 13, the third scan driver 136 according to one or more embodiments of the present disclosure may include a plurality of stage circuits ST1a, ST2a, ST3a, ST4a, . . . , and so on. Each of the stage circuits ST1a to ST4a may be electrically coupled to one of the third scan lines SL31, SL32, SL33, and SL34.

For example, the first stage circuit ST1a may be electrically connected to the third scan line SL31 and may supply an enabled third scan signal GR1 to the third scan line SL31. The second stage circuit ST2a may be electrically connected to the third scan line SL32, and may supply an enabled third scan signal GR2 to the third scan line SL32. The third stage circuit ST3a may be electrically connected to the third scan line SL33, and may supply an enabled third scan signal GR3 to the third scan line SL33. The fourth stage circuit ST4a may be electrically connected to the third scan line SL34, and may supply an enabled third scan signal GR4 to the third scan line SL34.

Each of the stage circuits ST1a to ST4a may have a first input terminal IN1a, a second input terminal IN2a, a third input terminal IN3a, a control input terminal CINa, and a reset input terminal RINa. Further, each of the stage circuits ST1a to ST4a may be provided with a first power input terminal VIN1a, a second power input terminal VIN2a, a third power input terminal VIN3a, a first control power input terminal DVIN1a, and a second control power input terminal DVIN2a. Further, each of the stage circuits ST1a to ST4a may be provided with a first output terminal OUT1a and a second output terminal OUT2a.

The start signal FLMa or a carry signal CRa of the previous stage circuit may be input to the first input terminal IN1a. For example, the start signal FLMa may be input to the first input terminal IN1a of the first stage circuit ST1a. In one example, a carry signal CR1a of the first stage circuit ST1a may be input to the first input terminal IN1a of the second stage circuit ST2a. In one example, a carry signal CR2a of the second stage circuit ST2a may be input to the first input terminal IN1a of the third stage circuit ST3a. In one example, a carry signal CR3a of the third stage circuit ST3a may be input to the first input terminal IN1a of the fourth stage circuit ST4a.

A first clock signal CLK1a or a third clock signal CLK3a may be input to the second input terminal IN2a. For example, the first clock signal CLK1a may be input to the second input terminal IN2a of the first stage circuit ST1a and the third stage circuit ST3a, and the third clock signal CLK3a may be input to the second input terminal IN2a of the second stage circuit ST2a and the fourth stage circuit ST4a.

The first clock signal CLK1a or the third clock signal CLK3a may be input to the third input terminal IN3a. For example, the third clock signal CLK3a may be input to the third input terminal IN3a of the first stage circuit ST1a and the third stage circuit ST3a, and the first clock signal CLK1a may be input to the third input terminal IN3a of the second stage circuit ST2a and the fourth stage circuit ST4a.

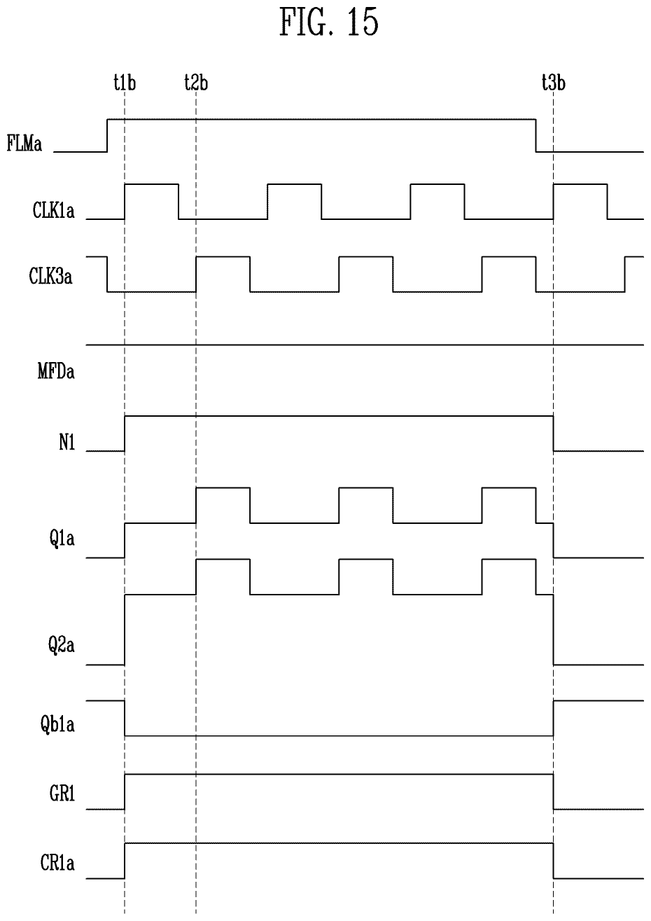

The first clock signal CLK1a and the third clock signal CLK3a may have the same period and different phases, as shown in FIG. 15. For example, the third clock signal CLK3 a may be 180 degrees out of phase with respect to the first clock signal CLK1a.

A frequency control signal MFDa may be input to the control input terminal CINa. The frequency control signal MFDa is a global signal and may be input to all stage circuits ST1a to ST4a in common. The stage circuits ST1a to ST4a may control whether the enabled third scan signal GR (or a scan signal) is output in response to the frequency control signal MFDa.

A reset signal Reseta may be input to the reset input terminal RINa. The reset signal Reseta is a global signal and may be input to all stage circuits ST1a to ST4a in common. The stage circuits ST1a to ST4a may be initialized to a desired state (e.g., a predetermined state) when the reset signal Reseta is input.

The first power VGH may be input to the first power input terminal VIN1a.

The second power VGL1 may be input to the second power input terminal VIN2a.

The third power VGL2 may be input to the third power input terminal VIN3a.

The first control power DVGH1 may be input to a first control power input terminal DVIN1a.

The second control power DVGH2 may be input to a second control power input terminal DVIN2a. The first control power DVGH1 and the second control power DVGH2 alternately repeat a high voltage (or a logic high voltage) and a low voltage (or a logic low voltage) on a frame-by-frame basis as shown in FIG. 8, and the high voltage of the first control power DVGH1 and the high voltage of the second control power DVGH2 may not overlap.

The enabled third scan signal GR may be output to the first output terminal OUT1a.

The carry signal CRa may be output to the second output terminal OUT2a.

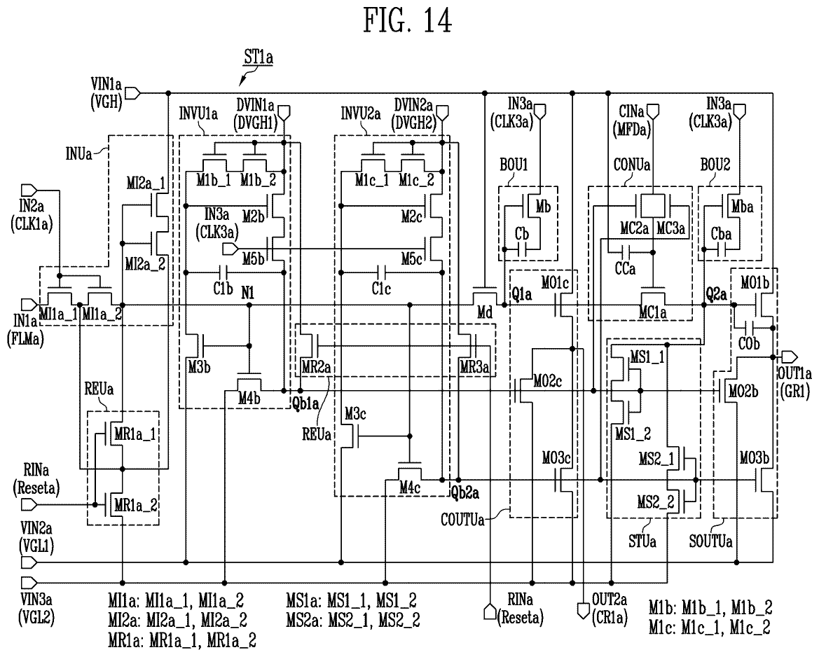

FIG. 14 is a circuit diagram illustrating the stage circuit shown in FIG. 13, according to one or more embodiments. In FIG. 14, the first stage circuit ST1a is shown for convenience of explanation, but the remaining stage circuits ST2a to ST4a may have substantially the same circuit as the first stage circuit ST1a. When a description is made with reference to FIG. 14, portions that are redundant with those described with reference to FIG. 9 will be omitted or briefly described.

Referring to FIG. 14, the stage circuit ST1a according to one or more embodiments of the present disclosure may include an input part INUa, a first inverter part INVU1a, a second inverter part INVU2a, a carry output part COUTUa, a scan output part SOUTUa, a control part CONUa, a reset part REUa, a stabilization part STUa, a first boosting part BOU1, a second boosting part BOU2, and a driving transistor Md. The stage circuit ST1a according to one or more embodiments of the present disclosure may be configured in various forms to include the control part CONUa.

The driving transistor Md may be connected between the first node N1 and a first control node Q1a. A gate electrode of the driving transistor Md may be connected to the first power input terminal VIN1a. The driving transistor Md is turned on by the first power VGH input to the first power input terminal VIN1a, and the first node N1 and the first control node Q1a may be electrically connected.

The input part INUa may be connected to the first input terminal IN1a, the second input terminal IN2a, and the first power input terminal VIN1a. The input part INUa may control the electrical connection of the first input terminal IN1a and the first node N1 in response to the first clock signal CLK1a input to the second input terminal IN2a. The input part INUa may be provided with a first input transistor MI1a and a second input transistor MI2a.

The first input transistor MI1a may be connected between the first input terminal IN1a and the first node N1. The first input transistor MI1a may be configured with a plurality of transistors MI1a_1 and MI1a_2 connected in series. A gate electrode of the first input transistor MI1a may be connected to the second input terminal IN2a. The first input transistor MI1a may be turned on when the first clock signal CLK1a is input to the second input terminal IN2a, thereby electrically connecting the first input terminal IN1a and the first node N1.

The input of the first clock signal CLK1a (or the supply of the first clock signal CLK1a) may mean that a gate-on voltage (e.g., a logic high voltage) for turning on the first input transistor MI1a is supplied to the second input terminal IN2a. In the following description, the clock signals CLK1a and CLK3a being input or supplied may mean that a gate-on voltage is input to the corresponding input terminal (at least one of IN2a and IN3a).

The second input transistor MI2a may be connected between the first power input terminal VIN1a and a common node of the first input transistors MI1a_1 and MI1a_2. The second input transistor MI2a may include a plurality of transistors MI2a_1 and MI2a_2 connected in series. A gate electrode of the second input transistor MI2a may be connected to the first node N1. Thus, the second input transistor MI2a may control the electrical connection between the first power input terminal VIN1a and the common node of the first input transistors MI1a_1 and MI1a_2 in response to the voltage of the first node N1.

The first inverter part INVU1a may be connected to the first control power input terminal DVIN1a, the second power input terminal VIN2a, the third input terminal IN3a, and the third power input terminal VIN3a. The first inverter part INVU1a may control the voltage of a first driving node Qb1a in response to the voltage of the first node N1. The first inverter part INVU1a may include a first transistor M1b, a second transistor M2b, a third transistor M3b, a fourth transistor M4b, a fifth transistor M5b, and a first capacitor C1b.

The first transistor M1b may be connected between the first control power input terminal DVIN1a and the gate electrode of a second transistor M2b. The first transistor M1b may be configured with a plurality of transistors M1b_1 and M1b_2 connected in series. A gate electrode of the first transistor M1b may be connected to the first control power input terminal DVIN1a. The first transistor M1b is connected in the form of a diode (e.g., the first transistor M1b may be diode-connected) to allow current to flow from the first control power input terminal DVIN1a to a gate electrode of the second transistor M2b.

The second transistor M2b may be connected between the first control power input terminal DVIN1a and the first driving node Qb1a. The gate electrode of the second transistor M2b may be connected to the first control power input terminal DVIN1a via the first transistor M1b. The second transistor M2b is connected in the form of a diode (e.g., the second transistor M2b may be diode-connected) to allow current to flow from the first control power input terminal DVIN1a to the first driving node Qb1a.

The first transistor M1b and the second transistor M2b may be turned on when the first control power DVGH1 of a logic high voltage is input to the first control power input terminal DVIN1a, thereby electrically connecting the first control power input terminal DVIN1a and the first driving node Qb1a.

The third transistor M3b may be connected between the gate electrode of the second transistor M2b and the second power input terminal VIN2a. A gate electrode of the third transistor M3b may be connected to the first node N1. The third transistor M3b may be turned on or off in response to the voltage of the first node N1.

The fourth transistor M4b may be connected between the first driving node Qb1a and the third power input terminal VIN3a. A gate electrode of the fourth transistor M4b may be connected to the first node N1. The fourth transistor M4b may be turned on or off in response to the voltage of the first node N1.

The fifth transistor M5b may be connected between the second transistor M2b and the first driving node Qb1a. A gate electrode of the fifth transistor M5b may be connected to the third input terminal IN3a. The fifth transistor M5b may be turned on when the third clock signal CLK3a is input to the third input terminal IN3a, thereby electrically connecting the second transistor M2b and the first driving node Qb1a.

The first capacitor C1b may be connected between the gate electrode of the second transistor M2b and the first driving node Qb1a.

The second inverter part INVU2a may be connected to the second control power input terminal DVIN2a, the second power input terminal VIN2a, the third input terminal IN3a, and the third power input terminal VIN3a. The second inverter part INVU2a may control the voltage of a second driving node Qb2a in response to the voltage of the first node N1.

The second inverter part INVU2a may include a first transistor M1c, a second transistor M2c, a third transistor M3c, a fourth transistor M4c, a fifth transistor M5c, and a first capacitor C1c.

The first transistor M1c may be connected between the second control power input terminal DVIN2a and a gate electrode of the second transistor M2c. The first transistor M1c may be configured with a plurality of transistors M1c_1 and M1c_2 connected in series. A gate electrode of the first transistor M1c may be connected to the second control power input terminal DVIN2a. The first transistor M1c is connected in the form of a diode (e.g., the first transistor M1c may be diode-connected) to allow current to flow from the second control power input terminal DVIN2a to the gate electrode of the second transistor M2c.

The second transistor M2c may be connected between the second control power input terminal DVIN2a and the second driving node Qb2a. The gate electrode of the second transistor M2c may be connected to the second control power input terminal DVIN2a via the first transistor M1c. The second transistor M2c is connected in the form of a diode (e.g., the second transistor M2c may be diode-connected) to allow current to flow from the second control power input terminal DVIN2a to the second driving node Qb2a.

The first transistor M1c and the second transistor M2c may be turned on when the second control power DVGH2 of a logic high voltage is input to the second control power input terminal DVIN2a, thereby electrically connecting the second control power input terminal DVIN2a and the second driving node Qb2a.

The third transistor M3c may be connected between the gate electrode of the second transistor M2c and the second power input terminal VIN2a. A gate electrode of the third transistor M3c may be connected to the first node N1. The third transistor M3c may be turned on or off in response to the voltage of the first node N1.

The fourth transistor M4c may be connected between the second driving node Qb2a and the third power input terminal VIN3a. A gate electrode of the fourth transistor M4c may be connected to the first node N1. The fourth transistor M4c may be turned on or off in response to the voltage of the first node N1.

The fifth transistor M5c may be connected between the second transistor M2c and the second driving node Qb2a. A gate electrode of the fifth transistor M5c may be connected to the third input terminal IN3a. The fifth transistor M5c may be turned on when the third clock signal CLK3a is input to the third input terminal IN3a to electrically connect the second transistor M2c and the second driving node Qb2a.

The first capacitor C1c may be connected between the gate electrode of the second transistor M2c and the second driving node Qb2a.

The first inverter part INVU1a and the second inverter part INVU2a may be alternately driven in response to the voltages of the first control power DVGH1 and the second control power DVGH2 repeating high and low voltages alternately in a frame-by-frame basis. For example, the first inverter part INVU1a and the second inverter part INVU2a may be alternately driven on a frame-by-frame basis to control the voltages of the first driving node Qb1a and the second driving node Qb2a.

The carry output part COUTUa may be connected to the first power input terminal VIN1a, the third power input terminal VIN3a, and the second output terminal OUT2a. The carry output part COUTUa may output a carry signal CR1a to the second output terminal OUT2a in response to the voltage of the first control node Q1a. The carry output part COUTUa may be provided with a first output transistor MO1c, a second output transistor MO2c, and a third output transistor MO3c.

The first output transistor MO1c may be connected between the first power input terminal VIN1a and the second output terminal OUT2a. A gate electrode of the first output transistor MO1c may be connected to the first control node Q1a. The first output transistor MO1c may be turned on or off in response to the voltage of the first control node Q1a to control the electrical connection of the first power input terminal VIN1a and the second output terminal OUT2a.

The second output transistor MO2c may be connected between the second output terminal OUT2a and the third power input terminal VIN3a. A gate electrode of the second output transistor MO2c may be connected to the first driving node Qb1a. The second output transistor MO2c may be turned on or off in response to a voltage of the first driving node Qb1a, thereby controlling an electrical connection between the second output terminal OUT2a and the third power input terminal VIN3a.

The third output transistor MO3c may be connected between the second output terminal OUT2a and the third power input terminal VIN3a. A gate electrode of the third output transistor MO3c may be connected to the second driving node Qb2a. Thus, the third output transistor MO3c may be turned on or off in response to a voltage of the second driving node Qb2a, thereby controlling an electrical connection between the second output terminal OUT2a and the third power input terminal VIN3a.

The scan output part SOUTUa may be connected to the first power input terminal VIN1a, the second power input terminal VIN2a, and the first output terminal OUT1a. The scan output part SOUTUa may output a scan signal (GR1) to the first output terminal OUT1a in response to a voltage of the second control node Q2a. The scan output part SOUTUa may include a first output transistor MO1b, a second output transistor MO2b, and a third output transistor MO3b.

The first output transistor MO1b may be connected between the first power input terminal VIN1a and the first output terminal OUT1a. A gate electrode of the first output transistor MO1b may be connected to the second control node Q2a. The first output transistor MO1b may be turned on or off in response to the voltage of the second control node Q2a to control the electrical connection of the first power input terminal VIN1a and the first output terminal OUT1a.

The second output transistor MO2b may be connected between the first output terminal OUT1a and the second power input terminal VIN2a. A gate electrode of the second output transistor MO2b may be connected to the first driving node Qb1a. The second output transistor MO2b may be turned on or off in response to a voltage of the first driving node Qb1a, thereby controlling an electrical connection between the first output terminal OUT1a and the second power input terminal VIN2a.

The third output transistor MO3b may be connected between the first output terminal OUT1a and the second power input terminal VIN2a. A gate electrode of the third output transistor MO3b may be connected to the second driving node Qb2a. The third output transistor MO3b may be turned on or off in response to a voltage of the second driving node Qb2a, thereby controlling an electrical connection between the first output terminal OUT1a and the second power input terminal VIN2a.

An output capacitor COb may be connected between the second control node Q2a and the first output terminal OUT1a. The output capacitor COb may control the voltage of the second control node Q2a in response to the voltage of the first output terminal OUT1a.

The control part CONUa may be connected to the control input terminal CINa. The control part CONUa may control the electrical connection of the first control node Q1a and the second control node Q2a in response to the frequency control signal MFDa input to the control input terminal CINa. The control part CONUa may include a first control transistor MC1a, a second control transistor MC2a, a third control transistor MC3a, and a control capacitor CCa.

The first control transistor MC1a may be connected between the first control node Q1a and the second control node Q2a.

The second control transistor MC2a and the third control transistor MC3a may be connected in parallel between a gate electrode of the first control transistor MC1a and the control input terminal CINa. A gate electrode of the second control transistor MC2a may be connected to the first driving node Qb1a. A gate electrode of the third control transistor MC3a may be connected to the second driving node Qb2a.

The control capacitor CCa may be connected between the gate electrode of the first control transistor MC1a and the first power input terminal VIN1a. The control capacitor CCa may store a suitable voltage (e.g., a predetermined voltage) corresponding to the frequency control signal MFDa.

The reset part REUa may be connected to the reset input terminal RINa, the first control power input terminal DVIN1a, and the second control power input terminal DVIN2a. The reset part REUa may initialize the first node N1 (and the first control node Q1a), the first driving node Qb1a, and the second driving node Qb2a to a desired state (e.g., a predetermined state). The reset part REUa may be provided with a first reset transistor MR1a, a second reset transistor MR2a, and a third reset transistor MR3a.

The first reset transistor MR1a may be connected between the first node N1 and the third power input terminal VIN3a. The first reset transistor MR1a may be configured with a plurality of transistors MR1a_1 and MR1a_2 connected in series, and a common node between the plurality of transistors MR1a_1 and MR1a_2 may be connected to the second input transistor MI2a. A gate electrode of the first reset transistor MR1a may be connected to the reset input terminal RINa. The first reset transistor MR1a may be turned on when the reset signal Reseta is input to the reset input terminal RINa to supply a voltage of the third power VGL2 (or a low voltage) to the first node N1.

The second reset transistor MR2a may be connected between the first control power input terminal DVIN1a and the first driving node Qb1a. A gate electrode of the second reset transistor MR2a may be connected to the reset input terminal RINa.

The third reset transistor MR3a may be connected between the second control power input terminal DVIN2a and the second driving node Qb2a. A gate electrode of the third reset transistor MR3a may be connected to the reset input terminal RINa.

The first control power DVGH1 and/or the second control power DVGH2 may be maintained at a high voltage during the period when the reset signal Reseta is input to the reset input terminal RINa. Accordingly, when the reset signal Reset is input to the reset input terminal RIN, the second reset transistor MR2a and/or the third reset transistor MR3a may be turned on, and a high voltage may be supplied to the first driving node Qb1a and/or the second driving node Qb2a accordingly.

The stabilization part STUa may be connected to the third power input terminal VIN3a. The stabilization part STUa may control the voltage of the second control node Q2a in response to the voltages of the first driving node Qb1a and the second driving node Qb2a. The stabilization section STUa may include a first stabilization transistor MS1a and a second stabilization transistor MS2a.

The first stabilization transistor MS1a may be connected between the second control node Q2a and the third power input terminal VIN3a. The first stabilization transistor MS1a may be configured with a plurality of transistors MS1_1 and MS1_2 connected in series. A gate electrode of the first stabilization transistor MS1a may be connected to the first driving node Qb1a. The first stabilization transistor MS1a may be turned on or off in response to a voltage of the first driving node Qb1a, thereby controlling an electrical connection of the second control node Q2a and the third power input terminal VIN3a.

The second stabilization transistor MS2a may be connected between the second control node Q2a and the third power input terminal VIN3a. The second stabilization transistor MS2a may include a plurality of transistors MS2_1 and MS2_2 connected in series. A gate electrode of the second stabilization transistor MS2a may be connected to the second driving node Qb2a. The second stabilization transistor MS2a may be turned on or off in response to a voltage of the second driving node Qb2a to control an electrical connection of the second control node Q2a and the third power input terminal VIN3a.

The first boosting part BOU1 may be connected to the third input terminal IN3a. The first boosting part BOU1 may control the voltage of the first control node Q1a in response to the third clock signal CLK3a input to the third input terminal IN3a. The first boosting part BOU1 may be provided with a boosting transistor Mb and a boosting capacitor Cb.

A first electrode of the boosting transistor Mb may be connected to the third input terminal IN3a, and a second electrode thereof may be connected to a first terminal of the boosting capacitor Cb. A gate electrode of the boosting transistor Mb may be connected to the first control node Q1a.

The first terminal of the boosting capacitor Cb may be connected to the second electrode of the boosting transistor Mb, and a second terminal thereof may be connected to the first control node Q1a. The boosting capacitor Cb may increase the voltage of the first control node Q1a when the third clock signal CLK3a is input to the first terminal of the boosting capacitor Cb.

The second boosting part BOU2 may be connected to the third input terminal IN3a. The second boosting part BOU2 may control the voltage of the second control node Q2a in response to the third clock signal CLK3a input to the third input terminal IN3a. The second boosting part BOU2 may be provided with a boosting transistor Mba and a boosting capacitor Cba.

A first electrode of the boosting transistor Mba may be connected to the third input terminal IN3a, and a second electrode thereof may be connected to a first terminal of the boosting capacitor Cba. A gate electrode of the boosting transistor Mba may be connected to the second control node Q2a.

The first terminal of the boosting capacitor Cba may be connected to the second electrode of the boosting transistor Mba, and a second terminal thereof may be connected to the second control node Q2a. The boosting capacitor Cba may increase the voltage of the second control node Q2a when the third clock signal CLK3a is input to the first terminal of the boosting capacitor Cba.

FIG. 15 is a waveform diagram illustrating a method of driving a stage circuit as shown in FIG. 14, according to one or more embodiments. When a description is made with reference to FIG. 15, it is assumed that the first control power DVGH1 maintains a high voltage, and the first inverter part INVU1a is driven accordingly. When a description is made with reference to FIG. 15, it is assumed that the frequency control signal MFDa maintains a high voltage. When a description is made with reference to FIG. 15, parts that are the same or similar to the parts described with reference to FIG. 10 will be omitted or briefly described.

Referring to FIG. 15, the first driving node Qb1a may be set to a high voltage during a period before a first time t1b. When the high voltage is input to the first driving node Qb1a, the second control transistor MC2a may be turned on. When the second control transistor MC2a is turned on, the frequency control signal MFDa of a high voltage is supplied to the gate electrode of the first control transistor MC1a, and the first control transistor MC1a may be turned on accordingly. In addition, the high voltage corresponding to the turn-on of the first control transistor MC1a may be stored in the control capacitor CCa.

At the first time t1b, the start signal FLMa of a high voltage may be input to the first input terminal IN1a, and the first clock signal CLK1a may be input to the second input terminal IN2a. When the first clock signal CLK1a is input to the second input terminal IN2a, the first input transistor MI1a may be turned on. When the first input transistor MI1a is turned on, the high-voltage start signal FLMa may be supplied to the first node N1 and the first control node Q1a.

When a high voltage is input to the first node N1, the third transistors M3b and M3c and the fourth transistors M4b and M4c may be turned on. When the third transistors M3b and M3c are turned on, the voltage of the second power source VGL1 is supplied to the gate electrodes of the second transistors M2b and M2c, and the second transistors M2b and M2c may be turned off. When the fourth transistors M4b and M4c are turned on, a voltage of the third power VGL2 (or a low voltage) may be supplied to the first driving node Qb1a and the second driving node Qb2a.

When a low voltage is input to the first driving node Qb1a, the second output transistors MO2b and MO2c, the first stabilization transistor MS1a, and the second control transistor MC2a may be turned off. When the driving voltage is input to the second driving node Qb2a, the third output transistors MO3b and MO3c, the second stabilization transistor MS2a, and the third control transistor MC3a may be turned off.

Even when the second control transistor MC2a and the third control transistor MC3a are turned off, the first control transistor MC1a may maintain the turn-on state by the voltage stored in the control capacitor CCa. Therefore, the high voltage supplied to the first control node Q1a may be supplied to the second control node Q2a via the first control transistor MC1a.

When the first control node Q1a and the second control node Q2a are set to a high voltage, the first output transistors MO1b and MO1c may be turned on.

When the first output transistor MO1b is turned on, the first power input terminal VIN1a and the first output terminal OUT1a may be electrically connected. A voltage of the first power VGH may be supplied to the first output terminal OUT1a. The voltage of the first power VGH supplied to the first output terminal OUT1a may be supplied to the third scan line SL31 as the enabled third scan signal GR1. The voltage of the second control node Q2a may be increased by boosting of the output capacitor COb.

When the first output transistor MO1c is turned on, the first power input terminal VIN1a and the second output terminal OUT2a may be electrically connected. A voltage of the first power VGH may be supplied to the second output terminal OUT2a. The voltage of the first power source VGH supplied to the second output terminal OUT2a may be supplied to the next stage circuit (e.g., the second stage circuit ST2a) as the carry signal CR1a.

At a second time t2b, the third clock signal CLK3a may be input (i.e., the high voltage is input) to the third input terminal IN3a.

At the second time t2b, the boosting transistor Mb is turned on by the high voltage of the first control node Q1a, and accordingly, the third clock signal CLK3a input to the third input terminal IN3a may be input to a first terminal of the boosting capacitor Cb. When the third clock signal CLK3a is input to the first terminal of the boosting capacitor Cb, the voltage of the first control node Q1a may rise. The first output transistor MO1c may stably maintain a turn-on state.

At the second time t2b, the boosting transistor Mba is turned on by the high voltage of the second control node Q2a, and accordingly, the third clock signal CLK3a input to the third input terminal IN3a may be input to a first terminal of the boosting capacitor Cba. When the third clock signal CLK3a is input to the first terminal of the boosting capacitor Cba, the voltage of the second control node Q2a may rise. The first output transistor MO1b may stably maintain a turn-on state.

At a third time t3b, the start signal FLMa of a low voltage may be input to the first input terminal IN1a, and the first clock signal CLK1a may be input to the second input terminal IN2a. When the first clock signal CLK1a is input to the second input terminal IN2a, the first input transistor MI1a may be turned on. When the first input transistor MI1a is turned on, the low-voltage start signal FLMa may be supplied to the first node N1, the first control node Q1a, and the second control node Q2a.

When the first control node Q1a and the second control node Q2a are set to the low voltage, the first output transistors MO1b and MO1c may be turned off.

When a low voltage is input to the first control node Q1a, the third transistors M3b and M3c and the fourth transistors M4b and M4c may be turned off. When the third transistor M3b and the fourth transistor M4b are turned off, a voltage of the first control power DVGH1 (i.e., the high voltage) may be input to the first driving node Qb1a by the second transistor M2b connected in the form of a diode (e.g., the diode-connected second transistor M2b).

When a high voltage is input to the first driving node Qb1a, the second output transistors MO2b and MO2c, the first stabilization transistor MS1a, and the second control transistor MC2a may be turned on. When the second output transistor MO2b is turned on, the voltage from the second power VGL1 may be supplied to the first output terminal OUT1a. When the second output transistor MO2c is turned on, the voltage of the third power VGL2 may be supplied to the second output terminal OUT2a.

When the first stabilization transistor MS1a is turned on, the voltage of the third power source VGL2 may be supplied to the second control node Q2a. The voltage of the third power source VGL2 may also be supplied to the first control node Q1a electrically connected to the second control node Q2a. The first output transistors MO1b and MO1c may be stably maintained in the turn-off state.

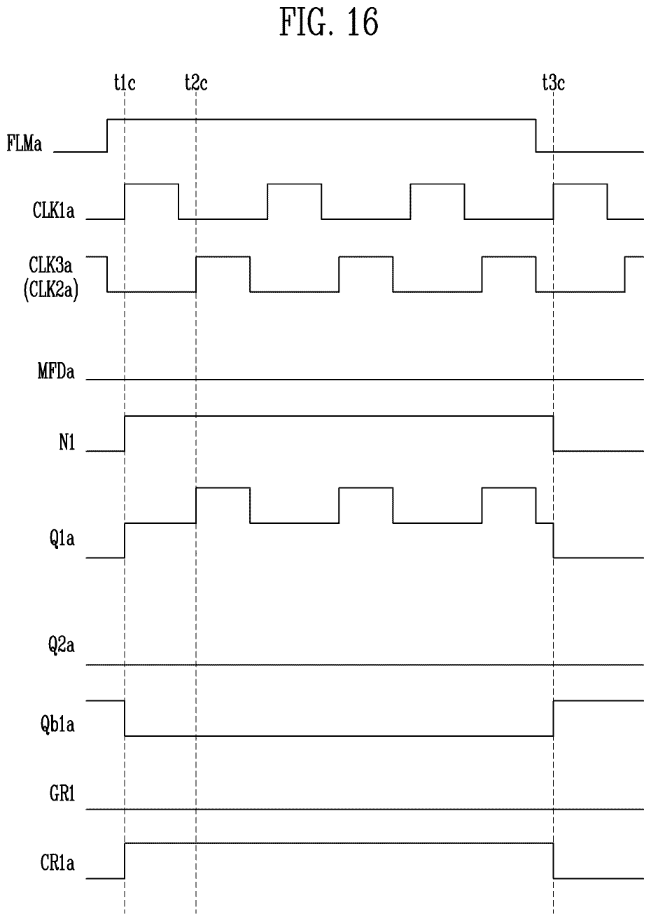

FIG. 16 is a waveform diagram illustrating a method of driving a stage circuit shown in FIG. 14, according to one or more embodiments. When a description is made with reference to FIG. 16, it is assumed that the first control power DVGH1 maintains a high voltage, and the first inverter part INVU1a is driven accordingly. In the description with reference to FIG. 16, it is assumed that the frequency control signal MFDa is maintained at a low voltage. When a description is made with reference to FIG. 16, parts that are redundant with the parts described with reference to FIG. 15 may be omitted or briefly described.

Referring to FIG. 16, during a period before a first time t1c, the first driving node Qb1a may be set to a high voltage. When the high voltage is input to the first driving node Qb1a, the second control transistor MC2a may be turned on. When the second control transistor MC2a is turned on, the frequency control signal MFDa of a low voltage is supplied to a gate electrode of the first control transistor MC1a, and the first control transistor MC1a may be turned off accordingly. In addition, a voltage corresponding to the turn-off of the first control transistor MC1a may be stored in the control capacitor CCa.

At the first time t1c, the start signal FLMa of a high voltage may be input to the first input terminal IN1a, and the first clock signal CLK1a may be input to the second input terminal IN2a. When the first clock signal CLK1a is input to the second input terminal IN2a, the first input transistor MI1a may be turned on. When the first input transistor MI1a is turned on, the high-voltage start signal FLMa may be supplied to the first node N1 and the first control node Q1a.

When a high voltage is input to the first node N1, the third transistors M3b and M3c and the fourth transistors M4b and M4c may be turned on. When the third transistors M3b and M3c are turned on, the voltage of the second power source VGL1 is supplied to gate electrodes of the second transistors M2b and M2c, and the second transistors M2b and M2c may be turned off. When the fourth transistors M4b and M4c are turned on, a voltage of the third power VGL2 (or a low voltage) may be supplied to the first driving node Qb1a and the second driving node Qb2a.

When a low voltage is input to the first driving node Qb1a, the second output transistors MO2b and MO2c, the first stabilization transistor MS1a, and the second control transistor MC2a may be turned off. When the low voltage is input to the second driving node Qb2a, the third output transistors MO3b and MO3c, the second stabilization transistor MS2a, and the third control transistor MC3a may be turned off.

Even when the second control transistor MC2a and the third control transistor MC3a are turned off, the first control transistor MC1a may remain in the turn-off state due to the voltage stored in the control capacitor CCa. Therefore, the high voltage supplied to the first control node Q1a is not supplied to the second control node Q2a.

When the first control node Q1a is set to a high voltage, the first output transistor MO1c may be turned on.

When the first output transistor MO1c is turned on, the first power input terminal VIN1a and the second output terminal OUT2a may be electrically connected. A voltage of the first power VGH may be supplied to the second output terminal OUT2a. The voltage of the first power VGH supplied to the second output terminal OUT2a may be supplied to the next stage circuit (e.g., the second stage circuit ST2a) as the carry signal CR1a.

When the second control node Q2a is set to a low voltage, the first output transistor MO1b may be turned off. Because the first output transistor MO1b is turned off, the first output terminal OUT1a remains at a low voltage.

At a second time t2c, the third clock signal CLK3a may be input (i.e., the high voltage is input) to the third input terminal IN3a.

At the second time t2c, the boosting transistor Mb is turned on by the high voltage of the first control node Q1a, and accordingly, the third clock signal CLK3a input to the third input terminal IN3a may be input to a first terminal of the boosting capacitor Cb. When the third clock signal CLK3a is input to the first terminal of the boosting capacitor Cb, the voltage of the first control node Q1a may rise. The first output transistor MO1c may stably maintain a turn-on state.

At the second time t2c, the second control node Q2a is set to a low voltage, and the boosting transistor Mba is accordingly maintained in a turn-off state. Thus, the second control node Q2a may maintain a low voltage regardless of the third clock signal CLK3a input to the third input terminal IN3a.

At a third time t3c, the start signal FLMa of a low voltage may be input to the first input terminal IN1a, and the first clock signal CLK1a may be input to the second input terminal IN2a. When the first clock signal CLK1a is input to the second input terminal IN2a, the first input transistor MI1a may be turned on. When the first input transistor MI1a is turned on, the low-voltage start signal FLMa may be supplied to the first node N1 and the first control node Q1a.

When the first control node Q1a is set to a low voltage, the first output transistor MO1c may be turned off.

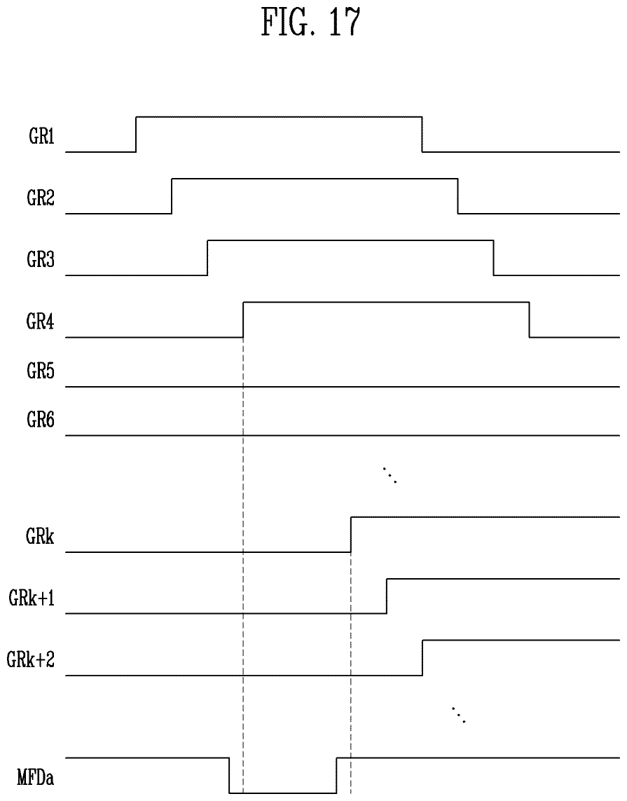

FIG. 17 is a waveform diagram indicating whether a scan signal corresponding to the frequency control signal is output, according to one or more embodiments.

Referring to FIG. 17, the third scan driver 136 (e.g., see FIG. 2) according to one or more embodiments of the present disclosure may control whether or not to output third scan signals (GR1, GR2, GR3, GR4, GR5, GR6, . . . , GRk, GRk+1, and GRk+2) in response to the frequency control signal MFDa.

For example, the third scan driver 136 (e.g., FIG. 2) may sequentially output the enabled third scan signals GR1 to GR4 in response to the frequency control signal MFDa of a high voltage. In addition, the third scan driver 136 may not output the third scan signals GR5, GR6, . . . (or may output a disabled third scan signal) in response to the frequency control signal MFDa of a low voltage. In addition, the third scan driver 136 may sequentially output the enabled third scan signals GRk, GRk+1, GRk+2, . . . in response to the high-voltage frequency control signal MFDa.

As described above, the third scan driver 136 according to one or more embodiments of the present disclosure may control whether or not to output the third scan signals GR1 to GRk+2, . . . by a region of the display panel 110 (e.g., see FIG. 1), and accordingly, at least two regions of the display panel 110 may be driven at different driving frequencies.

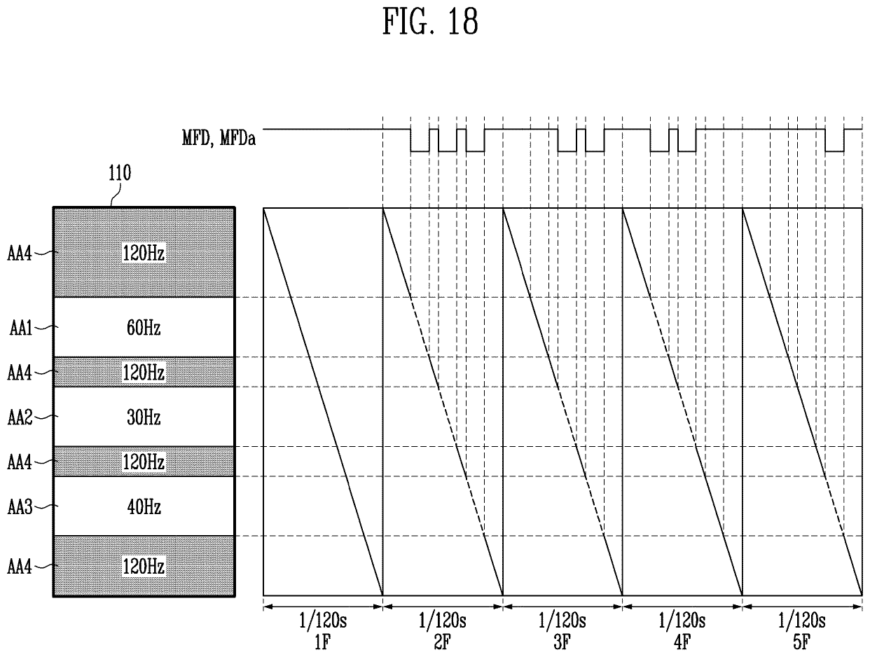

FIG. 18 is a diagram illustrating a case in which the display panel is divided into a plurality of regions, and the plurality of regions are driven at different driving frequencies. In FIG. 18, the frequency control signals MFD and MFDa are shown as identical signals, but the present disclosure is not limited thereto. The frequency control signals MFD and MFDa may be set to the same or different signals corresponding to the configuration of the stage circuits.

In FIG. 18, only the write period WP during which a data signal is input is considered, and the display panel 110 (e.g., see FIG. 1) is driven at a maximum of 120 Hz. In addition, 1/120s may mean 1/120 seconds, and each period may represent one frame of 120 Hz. In addition, in the frame, the solid line indicated by the oblique line may mean that the enabled first scan signal GW and the enabled third scan signal GR are supplied, and the dashed line indicated by the oblique line may mean that the enabled first scan signal GW and the enabled third scan signal GR are not supplied.

Referring to FIG. 18, a first area AA1 of the display panel 110 may be driven at 60 Hz, a second area AA2 at 30 Hz, a third area AA3 at 40 Hz, and a fourth area AA4 at 120 Hz.

During a first frame 1F, the enabled first scan signal GW and the enabled third scan signal GR may be supplied sequentially, independent of the areas AA1 to AA4.

During a second frame 2F, the enabled first scan signal GW and the enabled third scan signal GR may not be supplied to the first area AA1, the second area AA2, and the third area AA3, and the enabled first scan signal GW and the enabled third scan signal GR may be supplied to the fourth area AA4.

During a third frame 3F, the second area AA2 and the third area AA3 may not be supplied with the enabled first scan signal GW and the enabled third scan signal GR, while the first area AA1 and the fourth area AA4 may be supplied with the enabled first scan signal GW and the enabled third scan signal GR. A data signal may be supplied with a driving frequency of 60 Hz to the first area AA1.

During a fourth frame 4F, the first area AA1 and the second area AA2 may not be supplied with the enabled first scan signal GW and the enabled third scan signal GR, while the third area AA3 and the fourth area AA4 may be supplied with the enabled first scan signal GW and the enabled third scan signal GR. A data signal may be supplied to the third area AA3 with a driving frequency of 40 Hz.

During a fifth frame 5F, the third area AA3 may not be supplied with the enabled first scan signal GW and the enabled third scan signal GR, whereas the first area AA1, the second area AA2, and the fourth area AA4 may be supplied with the enabled first scan signal GW and the enabled third scan signal GR. The second area AA2 may be supplied with a data signal at a driving frequency of 30 Hz, and the fourth area AA4 may be supplied with a data signal at a driving frequency of 120 Hz.

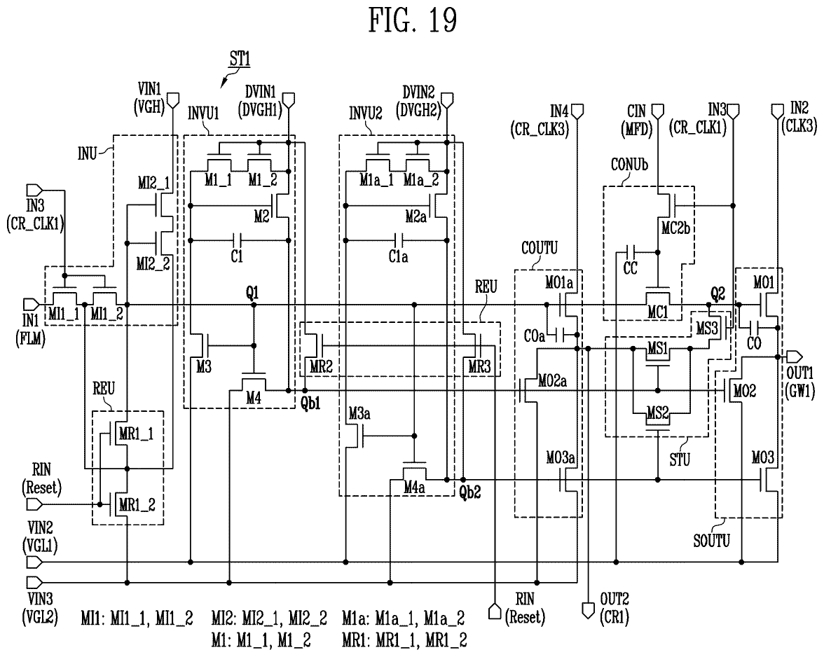

FIG. 19 is a diagram illustrating a stage circuit as shown in FIG. 6, according to one or more embodiments. When a description is made with reference to FIG. 19, the same configurations as in FIG. 9 will be assigned the same reference signs and detailed description will be omitted.

Referring to FIG. 19, the stage circuit ST1 according to one or more embodiments of the present disclosure may include the input part INU, the first inverter part INVU1, the second inverter part INVU2, the carry output part COUTU, the scan output part SOUTU, a control part CONUb, the reset part REU, and the stabilization part STU.

The control part CONUb may be connected to the control input terminal CIN. The control part CONUb may control the electrical connection of the first control node Q1 and the second control node Q2 in response to the frequency control signal MFD input to the control input terminal CIN. The control part CONUb may include the first control transistor MC1, the second control transistor MC2b, and the control capacitor CC.

The second control transistor MC2b may be connected between the gate electrode of the first control transistor MC1 and the control input terminal CIN. The gate electrode of the second control transistor MC2b may be connected to the third input terminal IN3. Thus, the second control transistor MC2b may be turned on or off in response to the first carry clock signal CR_CLK1 input to the third input terminal IN3, thereby controlling the electrical connection between the gate electrode of the first control transistor MC1 and the control input terminal CIN.

The stage circuit ST1 as shown in FIG. 19 may be identical to the stage circuit ST1 as shown in FIG. 9, except that the second control transistor M2b is driven in response to the first carry clock signal CR_CLK1, and other driving processes may be identical to those for the stage circuit ST1 as shown in FIG. 9.

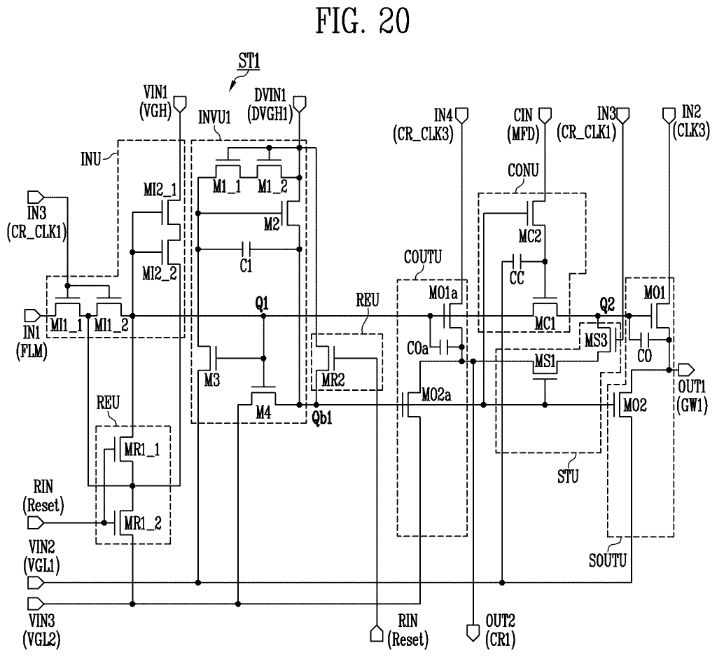

FIG. 20-22 are diagrams illustrating the stage circuit ST1 according to one or more embodiments of the present disclosure.

Referring to FIG. 20, the stage circuit ST1 as shown in FIG. 20 represents a configuration in which the second inverter INVU2 is removed from the stage circuit ST1 as shown in FIG. 9. For example, compared to the stage circuit ST1 shown in FIG. 9, the second inverter INVU2 and the transistors MO3, MO3a, MS2, MR3, and MC3 driven by the second inverter INVU2 (or driven by the second driving node Qb2) may be removed from the stage circuit ST1 shown in FIG. 20. The first control power DVGH1 may remain at a high voltage regardless of the change in frame.

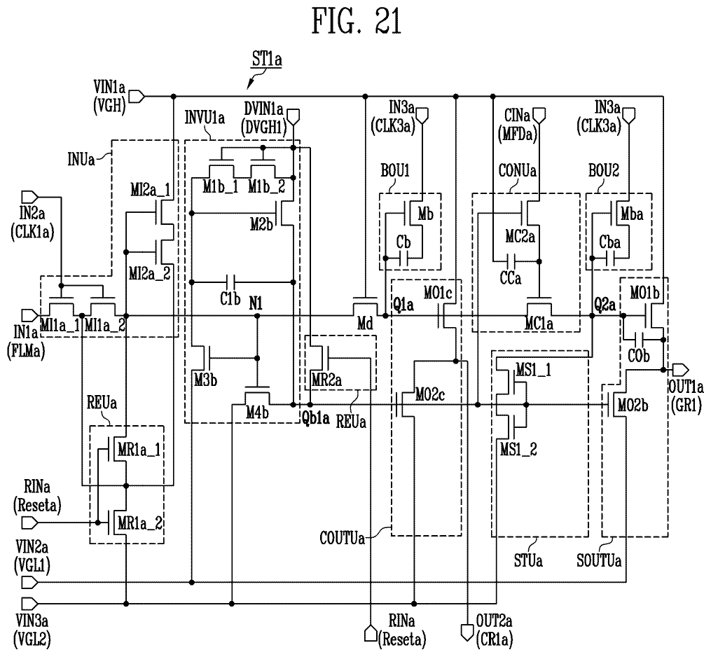

Referring to FIG. 21, the stage circuit ST1a shown in FIG. 21 illustrates a configuration in which the second inverter INVU2a is removed from the stage circuit ST1a shown in FIG. 14. For example, compared to the stage circuit ST1a shown in FIG. 14, the second inverter INVU2a and the transistors MO3b, MO3c, MS2a, MR3a, and MC3a driven by the second inverter INVU2a (or driven by the second driving node Qb2a) may be removed from the stage circuit ST1a shown in FIG. 21. The first control power DVGH1 may maintain a high voltage independent of the change in the frame.

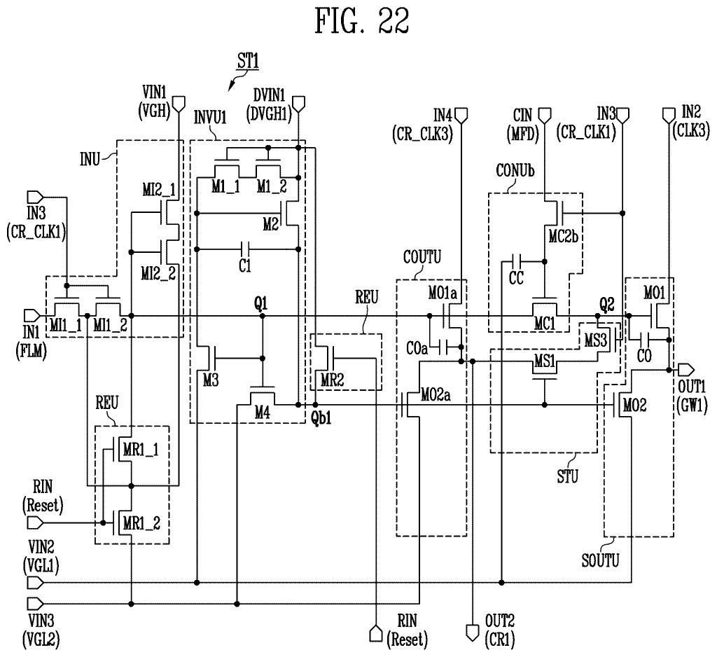

Referring to FIG. 22, the stage circuit ST1 shown in FIG. 22 illustrates a configuration in which the second inverter INVU2 is removed from the stage circuit ST1 shown in FIG. 19. For example, compared to the stage circuit ST1 shown in FIG. 19, the second inverter INVU2 and the transistors MO3, MO3a, MS2, MR3 driven by the second inverter INVU2 (or driven by the second driving node Qb2) may be removed from the stage circuit ST1 shown in FIG. 22. The first control power DVGH1 may maintain a high voltage independent of the change of the frame.

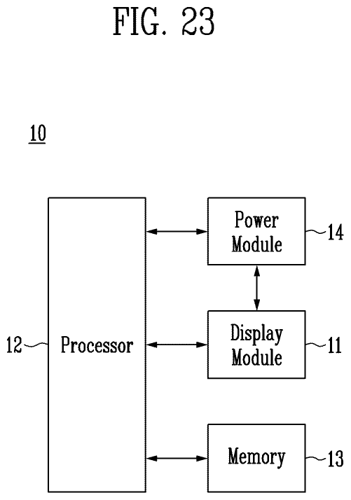

FIG. 23 is a diagram illustrating an electronic device 10 according to one or more embodiments of the present disclosure.

Referring to FIG. 23, the electronic device 10 according to one or more embodiments may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to the above-described embodiments. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

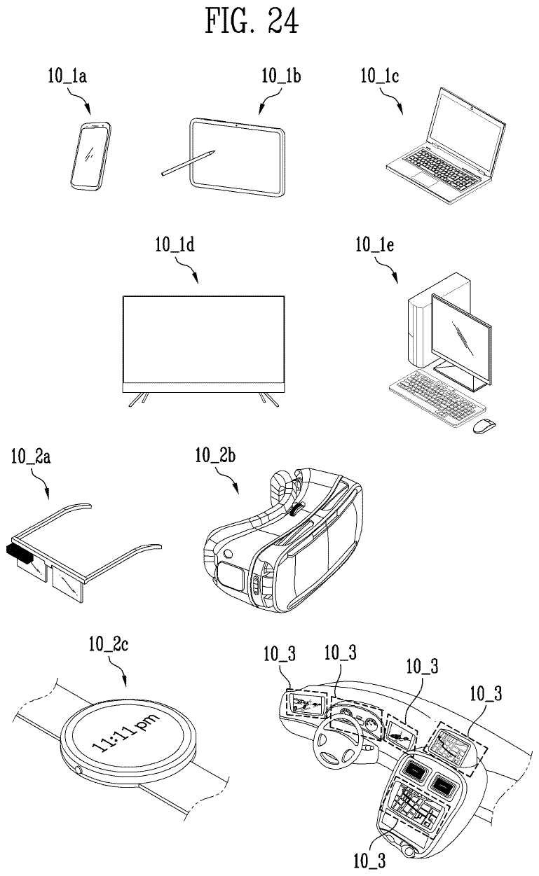

FIG. 24 shows schematic views of various embodiments of an electronic device.

Referring to FIG. 24, various types of electronic devices to which embodiments of the display device 100 of FIG. 1 are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

According to embodiments of the present disclosure, a stage circuit included in a scan driver may control the electrical connection of a carry output part that outputs a carry signal and a scan output part that outputs a scan signal in response to a frequency control signal, so that the number of times the scan signal is supplied to each region of a display panel may be controlled differently, and the regions of the display panel may be driven at different driving frequencies.

However, the effects, aspects, and features of embodiments of the present disclosure are not limited to those described above, and may be variously modified or extended without departing from the spirit and scope of the present disclosure.

The embodiments described above are provided to explain the present disclosure, but these embodiments are not intended to limit the scope of the present disclosure. It will be understood by those skilled in the art that various changes, substitutions, and alternatives may be made therein without departing from the spirit and scope of the disclosure as set forth by the claims and their equivalents. Therefore, the technical scope of the present disclosure may be determined based on the scope of the accompanying claims and their functional equivalents.

What is claimed is:

1. A scan driver comprising:
a plurality of stage circuits configured to supply a scan signal to scan lines,
wherein at least one of the plurality of stage circuits comprises:
a carry output part configured to carry a carry signal in response to a voltage of a first control node;
a scan output part configured to output the scan signal in response to a voltage of a second control node; and
a control part connected between the first control node and the second control node, and configured to control an electrical connection between the first control node and the second control node in response to a frequency control signal.

2. The scan driver of claim 1, wherein the control part is configured to electrically connect the first control node and the second control node when the frequency control signal is at a first level, and configured to electrically disconnect the first control node and the second control node when the frequency control signal is at a second level.

3. The scan driver of claim 1, wherein the at least one of the plurality of stage circuits further comprises:
an input part configured to control the voltage of the first control node in response to a start signal or a carry signal from a previous stage circuit; and
a first inverter part configured to control a voltage of a first driving node in response to the voltage of the first control node.

4. The scan driver of claim 3, wherein the control part comprises:
a first control transistor connected between the first control node and the second control node;
a second control transistor connected between a control input terminal to which the frequency control signal is input and a gate electrode of the first control transistor, the second control transistor comprising a gate electrode connected to the first driving node; and
a control capacitor connected between the gate electrode of the first control transistor and a first low power input terminal to which a first logic low voltage is input.

5. The scan driver of claim 4, wherein the at least one of the plurality of stage circuits further comprises a second inverter part configured to control a voltage of a second driving node in response to the voltage of the first control node.

6. The scan driver of claim 5, wherein the first inverter part is driven when a first control power is at a high voltage, and the second inverter part is driven when a second control power is at a high voltage, and
wherein the first control power and the second control power alternate between the high voltage and a low voltage in units of at least one frame.

7. The scan driver of claim 5, wherein the control part further comprises a third control transistor connected in parallel with the second control transistor, the third control transistor comprising a gate electrode connected to the second driving node.

8. The scan driver of claim 5, wherein the at least one of the plurality of stage circuits further comprises:
a reset part connected to a second low power input terminal to which a second logic low voltage is input, the reset part being configured to initialize the first control node, the first driving node, and the second driving node in response to a reset signal; and
a stabilization part configured to supply the second logic low voltage to the second control node in response to a carry clock signal.

9. The scan driver of claim 3, wherein the control part comprises:
a first control transistor connected between the first control node and the second control node,
a second control transistor connected between a control input terminal to which the frequency control signal is input and a gate electrode of the first control transistor, the second control transistor comprising a gate electrode configured to receive a carry clock signal; and
a control capacitor connected between the gate electrode of the first control transistor and a first low power input terminal to which a first logic low voltage is input.

10. The scan driver of claim 1, wherein the at least one of the plurality of stage circuits further comprises:
an input part configured to control the voltage of the first control node in response to a start signal or a carry signal from a previous stage circuit;
a driving transistor connected between the first control node and the first control node, the driving transistor comprising a gate electrode connected to a high power input terminal to which a logic high voltage is input such that the driving transistor is maintained in a turn-on state; and
a first inverter part configured to control a voltage of a first driving node in response to the voltage of the first control node.

11. The scan driver of claim 10, wherein the control part comprises:
a first control transistor connected between the first control node and the second control node;
a second control transistor connected between a control input terminal to which the frequency control signal is input and a gate electrode of the first control transistor, the second control transistor comprising a gate electrode connected to the first driving node; and
a control capacitor connected between a gate electrode of the first control transistor and the high power input terminal.

12. The scan driver of claim 11, wherein the at least one of the plurality of stage circuits further comprises a second inverter part configured to control a voltage of a second driving node in response to the voltage of the first control node.

13. The scan driver of claim 12, wherein the first inverter part is driven when a first control power is at a high voltage, and the second inverter part is driven when a second control power is at a high voltage, and
wherein the first control power and the second control power alternate between the high voltage and a low voltage in units of at least one frame.

14. The scan driver of claim 12, wherein the control part further comprises a third control transistor connected in parallel with the second control transistor, the third control transistor comprising a gate electrode connected to the second driving node.

15. The scan driver of claim 12, wherein the at least one of the plurality of stage circuits further comprises:
a reset part connected to a low voltage input terminal to which a logic low voltage is input, the reset part being configured to initialize the first control node, the first driving node, and the second driving node in response to a reset signal;
a stabilization part configured to control whether the logic low voltage is supplied to the second control node of or not in response to the voltage of the first driving node and the voltage of the second driving node;
a first boosting part configured to control the voltage of the first control node in response to a clock signal when the clock signal is input; and
a second boosting part configured to control the voltage of the second control node in response to the clock signal when the clock signal is input.

16. A display device, comprising:
a display panel comprising pixels connected to scan lines and data lines; and
a scan driver having a plurality of stage circuits configured to supply a scan signal to the scan lines,
wherein at least one of the plurality of stage circuits comprises:
a carry output part configured to output a carry signal in response to a voltage of a first control node;
a scan output part configured to output the scan signal in response to a voltage of a second control node; and
a control part connected between the first control node and the second control node, and configured to control an electrical connection between the first control node and the second control node in response to a frequency control signal.

17. The display device of claim 16, wherein the control part is configured to electrically connect the first control node and the second control node when the frequency control signal is at a first level, and configured to electrically disconnect the first control node and the second control node when the frequency control signal is at a second level.

18. The display device of claim 17, wherein the display panel further comprises a first area and a second area, and the first area and the second area are driven at different driving frequencies when the first area and the second area are supplied with different levels of the frequency control signal.

19. An electronic device, comprising:
a processor;
a display module configured to display image information under control of the processor; and
a memory configured to store data information for operations of the processor and the display module,
wherein the display module comprises:
a display panel comprising pixels connected to scan lines and data lines; and
a scan driver comprising a plurality of stage circuits configured to supply a scan signal to the scan lines, and
wherein at least one of the plurality of stage circuits comprises:
a carry output part configured to carry a carry signal in response to a voltage of a first control node;
a scan output part configured to output the scan signal in response to a voltage of a second control node; and
a control part connected between the first control node and the second control node, and configured to control an electrical connection between the first control node and the second control node in response to a frequency control signal.

20. The electronic device of claim 19, wherein the control part electrically connects the first control node and the second control node when the frequency control signal is at a first level, and electrically disconnects the first control node and the second control node when the frequency control signal is at a second level.
